(19) United States
(12) Patent Application Publication
(10) Pub. No.: US 2019/0094421 A1
(43) Pub. Date: Mar. 28, 2019

(54) ANTIREFLECTION FILM AND METHOD OF MANUFACTURING ANTIREFLECTION FILM

(71) Applicant: FUJIFILM Corporation, Tokyo (JP)

(72) Inventors: Shuntaro IBUKI, Kanagawa (JP); Takayasu YAMAZAKI, Kanagawa (JP); Daiki WAKIZAKA, Kanagawa (JP)

(73) Assignee: FUJIFILM Corporation, Tokyo (JP)

(21) Appl. No.: 16/108,842

(22) Filed: Aug. 22, 2018

Related U.S. Application Data
(63) Continuation of application No. PCT/JP2017/006953, filed on Feb. 23, 2017.

(30) Foreign Application Priority Data
Feb. 25, 2016 (JP) 2016-033786

(51) Int. Cl. G02B 1/118; G02B 5/30; G02B 1/111; G02B 5/02; B29D 11/00; B32B 27/20

(52) U.S. Cl. CPC G02B 1/118; G02B 5/3033; G02B 1/111; G02B 5/0226; B32B 27/20; B29D 11/00644; B29D 11/00788; B29D 11/00865; G02B 5/0294

(57) ABSTRACT

An antireflection film includes at least one antireflection layer on a substrate, the antireflection layer contains a cured product of a curable composition containing a lubricant (a) having three or more crosslinking groups in one molecule, having a crosslinking group equivalent of 450 or less, and having a moiety including at least one of a fluorine atom or a siloxane bond, a curable compound (b) having three or more crosslinking groups in at least one molecule, having a crosslinking group equivalent of 450 or less, and not having both of a fluorine atom and a siloxane bond, and a photopolymerization initiator (c), in an area (S) has defined herein, and has an area having a content of the lubricant (a) of 51% or more in a material distribution in a cross section direction of the area (S).

### CROSS REFERENCE TO RELATED APPLICATION

This is a continuation of International Application No. PCT/JP2017/006953 filed on Feb. 23, 2017, and claims priority from Japanese Patent Application No. 2016-033786 filed on Feb. 25, 2016, the entire disclosures of which are incorporated herein by reference.

### BACKGROUND OF THE INVENTION

### 1. Field of the Invention

The present invention relates to an antireflection film and a method of manufacturing an antireflection film.

### 2. Description of the Related Art

In an image display device such as a cathode ray tube display (CRT), a plasma display (PDP), an electroluminescent display (ELD), a vacuum fluorescent display (VFD), a field emission display (FED), and a liquid crystal display device (LCD), an antireflection film may be provided in order to prevent decrease in contrast due to reflection of external light on a display surface and reflected glare of an image. In addition to the image display device, the antireflection function may be provided to a glass surface of the showroom or the like by an antireflection film.

As an antireflection film arranged on the front surface of a display to be used, JP5055763B discloses an antireflection film having at least three or more reactive groups polymerizable by irradiation with active energy rays in one molecule and including polyorganosiloxane in which an urethane bond is formed between polydimethylsiloxane, diisocyanate or triisocyanate, and polyester containing a polymerizable reactive group.

The plastic molded article is also generally coated with a coating film in view of protecting the surface thereof from damage and the like. JP5625931B discloses a curable resin composition including a (meth)acrylate compound having a specific structure in which a polysiloxane moiety and five or more (meth)acryloyloxy groups are included in a molecule, urethane (meth)acrylate, and a photopolymerization initiator.

As the antireflection film, an antireflection film having a fine uneven shape with a period equal to or less than the wavelength of visible light on the surface of a substrate, that is, an antireflection film having a so-called moth eye structure is known. The moth eye structure makes a refractive index gradient layer in which the refractive index of the visible light successively changes from the air toward the bulk material inside the substrate, and reflection of the light can be prevented.

As an antireflection film having a moth eye structure, JP2009-139796A discloses the antireflection film having a moth eye structure manufactured by a method of coating a transparent substrate with a coating liquid containing a transparent resin monomer and a fine particle, curing the coating liquid, forming a transparent resin in which a fine particle is dispersed, and then etching the transparent resin.

### SUMMARY OF THE INVENTION

However, a thin and lightweight display which is represented by a liquid crystal display device (LCD) and an organic EL display device (OLED) has been widespread. As goods, situations, and usage forms in which the display is used become wider and more complicated, in the techniques of JP5055763B, JP5625931B, and JP2009-139796A, required scratch resistance (mainly steel wool rubbing) is still insufficient and the performance thereof requires further improvement. Further, the antireflection performance is insufficient at the level disclosed in JP5055763B.

An object of the present invention is to provide an antireflection film having satisfactory antireflection performance, a small reflectance change before and after a scratch resistance test, and excellent practical scratch resistance and to provide a method of easily manufacturing the antireflection film.

In order to solve the above problems, the present inventors have diligently conducted research so as to reach the conclusion that it is important to balance the sliding properties and the density of the crosslinking groups of a material for particularly forming an extremely shallow area of the surface of the antireflection layer. Particularly, the case where the antireflection layer has a moth eye structure having an uneven shape on the surface thereof is remarkable. Since only the sliding properties are emphasized in the lubricant in the related art and the density of the crosslinking group of the material is not high, even in a case where the lubricant is present on an outermost surface of the protrusion of the moth eye structure, the lubricant effectively acts at the beginning of the scratch resistance test, but is immediately scraped, and thus does not maintain sliding properties, such that the antireflection layer is scratched. In contrast, it was understood that, in a case where a specific material having the high density of the crosslinking and sliding properties is used, a coating film having high density of the crosslinking groups and sliding properties is formed on the outermost surface of the protrusion of the moth eye structure. Therefore, the antireflection layer can withstand the load concentrated on the protrusions in the scratch resistance test in which rubbing is repeatedly performed such that the uneven shape can be maintained and scratching can be prevented. That is, the present inventors have found that the above object can be achieved by the following means.

<1>

An antireflection film comprising:

at least one antireflection layer on a substrate,

in which the antireflection layer includes a cured product of a curable composition including

a lubricant (a) having three or more crosslinking groups in one molecule, having a crosslinking group equivalent of 450 or less, and having a moiety including at least one of a fluorine atom or a siloxane bond,

a curable compound (b) having three or more crosslinking groups in at least one molecule, having a crosslinking group equivalent of 450 or less, and not having both of a fluorine atom and a siloxane bond, and

a photopolymerization initiator (c),

in an area (S) having a thickness of 20 nm or less in a direction from an outermost surface of the antireflection layer, opposite to a surface of the antireflection layer at a side of the substrate, toward the substrate, and

has an area having a content of the lubricant (a) of 51% or more in a material distribution in a cross section direction of the area (S).

<2>

The antireflection film according to <1>, in which, in a case where a reflectance of the antireflection film after the outermost surface of the antireflection layer, opposite to the surface of the antireflection layer at a side of the substrate, is rubbed by 10 round trips with steel wool in a condition of a load of 200 g is set as R_{A}, and a reflectance of the antireflection film before being rubbed with steel wool is set as R₀, a reflectance change represented by R_{A}-R₀ is 0.25% or less.

<3>

The antireflection film according to <1> or <2>, in which the crosslinking group of the lubricant (a) is a (meth)acryloyl group.

<4>

The antireflection film according to any one of <1> to <3>, in which the moiety including at least one of a fluorine atom or a siloxane bond of the lubricant (a) is a fluoroalkyl group.

<5>

The antireflection film according to any one of <1> to <3>, in which the moiety including at least one of a fluorine atom or a siloxane bond of the lubricant (a) is a polydimethylsiloxane group or a polyether-modified dimethylsiloxane group.

<6>

The antireflection film according to <4> or <5>, in which the lubricant (a) is a compound (a1) having the moiety including at least one of a fluorine atom or a siloxane bond and the crosslinking group in a side chain and having a weight-average molecular weight of 6,000 or more.

<7>

The antireflection film according to <6>, in which, in the compound (a1), the crosslinking group is linked to a main chain via a C—C bond or a C—O bond.

<8>

The antireflection film according to <4> or <5>, in which the lubricant (a) is a compound (a2) in which the crosslinking group is bonded to the moiety including at least one of a fluorine atom or a siloxane bond, directly or via a linking group and which has a weight-average molecular weight of less than 6,000.

<9>

The antireflection film according to <8>, in which the compound (a2) is

a compound having one group represented by Formula (M-2),

a compound having one group represented by Formula (M-3),

a compound having two groups represented by Formula (M-1),

a compound having two groups represented by Formula (M-2), or

a compound having two groups represented by Formula (M-3).

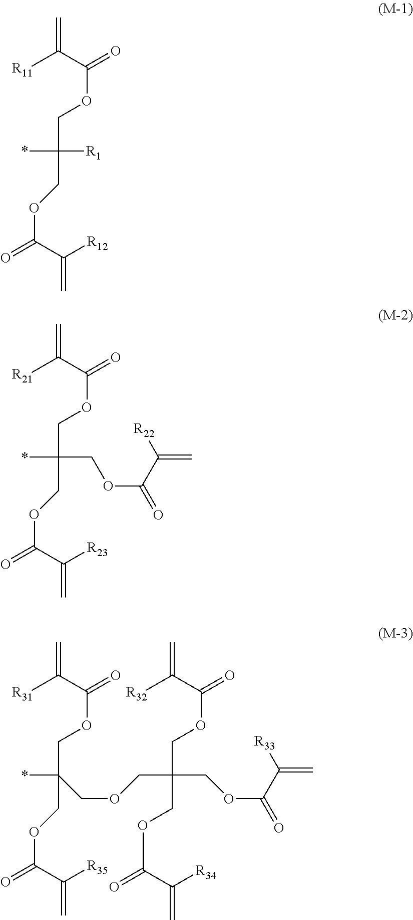

In Formula (M-1), R₁ represents a hydrogen atom, an alkyl group, an alkenyl group, an alkyloxy group, an alkenyloxy group, an alkyloxyalkyl group, or an alkenyloxyalkyl group. R₁₁ and R₁₂ each independently represent a hydrogen atom or a methyl group. * represents a bonding position.

In Formula (M-2), R₂₁ to R₂₃ each independently represent a hydrogen atom or a methyl group. * represents a bonding position.

In Formula (M-3), R₃₁ to R₃₅ each independently represent a hydrogen atom or a methyl group. * represents a bonding position.

<10>

The antireflection film according to <8>, in which in the compound (a2), the moiety including at least one of a fluorine atom or a siloxane bond and the crosslinking group are bonded to each other via a C—C bond or a C—O bond.

<11>

The antireflection film according to any one of <1> to <10>, in which the antireflection layer has a particle (d) having an average primary particle diameter of 250 nm or less.

<12>

The antireflection film according to <11>, having an uneven shape formed by the particle (d) on a surface of the antireflection layer opposite to the substrate side.

<13>

The antireflection film according to any one of <1> to <12>, in which a transmittance of visible light with respect to the substrate is 80% or more.

<14>

The antireflection film according to <12>, in which a plurality of the particles (d) are not present in a direction orthogonal to a surface of the substrate in the antireflection layer.

<15>

A method of manufacturing the antireflection film according to <12>, comprising, in order:

a step (1) of coating the substrate with a composition including the lubricant (a), the curable compound (b), the photopolymerization initiator (c), the particle (d), and a solvent, and volatilizing the solvent, to provide a layer (A) in which a thickness of a portion in which the particle (d) is not present is a thickness of 0.8 times or more of the average primary particle diameter of the particle (d);

a step (2) of curing a portion of the curable compound (b) in the layer (A) so as to obtain a cured compound (bc);

a step (3) of permeating a portion of a compound selected from the group consisting of the curable compound (b) and the compound (bc) in the layer (A) to the substrate by heating or volatilizing the portion so as to form an uneven shape formed by the particle (d) on an outermost surface of the layer (A) opposite to the substrate side; and

a step (4) of curing a compound selected from the group consisting of the lubricant (a), the curable compound (b), and the compound (bc) remaining in the layer (A) so as to form the antireflection layer.

<16>

The method of manufacturing an antireflection film according to <15>, further comprising:

a step (E1) of providing a layer (E) including a compound (e) incompatible with the curable compound (b) on a surface opposite to a surface of the layer (A) on the substrate side between the step (1) and the step (2), between the step (2) and the step (3), or between the step (3) and the step (4); and

a step (E2) of removing the layer (E) after the step (2), the step (3), or the step (4) subsequent to the step (E1).

According to the present invention, it is possible to provide an antireflection film having satisfactory antireflection performance, a small reflectance change before and after a scratch resistance test, and excellent practical scratch resistance, and it is possible to suggest a method of easily manufacturing the antireflection film.

### BRIEF DESCRIPTION OF THE DRAWINGS

FIG. 1 is a schematic view illustrating an example of a method of manufacturing an antireflection film of the present invention.

FIG. 2 is a schematic cross sectional view illustrating an example of the antireflection film of the present invention.

FIG. 3 is a schematic cross sectional view illustrating another example of the antireflection film of the present invention.

FIG. 4 is a schematic cross sectional view illustrating another example of the antireflection film of the present invention.

### DESCRIPTION OF THE PREFERRED EMBODIMENTS

Hereinafter, a preferable embodiment according to the present invention is specifically described. The following description of components will be made based on a representative embodiment of the present invention, but the present invention is not limited to the embodiment.

“(Meth)acrylate” refers to at least one of acrylate or methacrylate, “(meth)acryl” refers to at least one of acryl or methacryl, and “(meth)acryloyl” refers to at least one of acryloyl or methacryloyl.

[Antireflection Film]

The antireflection film of the present invention is an antireflection film having

at least one antireflection layer on a substrate.

in which the antireflection layer includes a cured product of a curable composition including

a lubricant (a) having three or more crosslinking groups in one molecule, having a crosslinking group equivalent (equivalent weight) of 450 or less, and having a moiety including at least one of a fluorine atom or a siloxane bond;

a curable compound (b) having three or more crosslinking groups in at least one molecule, having a crosslinking group equivalent of 450 or less, and not having both of a fluorine atom and a siloxane bond:

a photopolymerization initiator (c),

in an area (S) having a thickness of 20 nm or less in a direction from an outermost surface of the antireflection layer, opposite to a surface of the antireflection layer at a side of the substrate, toward the substrate, and

has an area having a content of the lubricant (a) of 51% or more in a material distribution in a cross section direction of the area (S).

FIGS. 3 and 4 are schematic cross sectional views illustrating examples of the antireflection film of the present invention, respectively.

<Lubricant (a)>

The lubricant (a) is described.

The lubricant (a) has three or more crosslinking groups in one molecule, has a crosslinking group equivalent of 450 or less, and has a moiety (hereinafter, this moiety is also referred to as a “low friction moiety”) including at least one of a fluorine atom or a siloxane bond.

Examples of the crosslinking group include a radical reactive group or a reactive group other than the radical reactive group, and a radical reactive group is preferable.

Examples of the radical reactive group include a group having an addition polymerizable unsaturated bond (for example, a (meth)acryloyl group, a (meth)acrylamide group, a (meth)acrylonitrile group, an allyl group, a vinyl group, a styrene structure, a vinyl ether structure, and an acetylene structure), —SH, —PH, SiH, —GeH, and a disulfide structure. A polymerizable functional group (a group having a polymerizable carbon-carbon unsaturated double bond) such as a (meth)acryloyl group, a vinyl group, a styryl group, and an allyl group is preferable. Among these, a (meth)acryloyl group and —C(O)OCH═CH₂ are more preferable, and a (meth)acryloyl group is most preferable.

Examples of the reactive group other than the radical reactive group include an epoxy group, an amino group, a boronic acid group, a boronic acid ester group, an oxiranyl group, an oxetanyl group, a hydroxyl group, a carboxyl group, and an isocyanate group.

The crosslinking group equivalent of the lubricant (a) is a value obtained by dividing a molecular weight of the lubricant (a) by the number of crosslinking groups included in the lubricant (a), and is 450 or less, more preferably 350 or less, and even more preferably 300 or less in view of film hardness after curing.

For example, the crosslinking group equivalent in the case where the crosslinking group is an acryloyl group or a methacryloyl group is referred to as an acryl equivalent.

The lubricant (a) is preferably a compound (a1) that has a crosslinking group and a low friction moiety in a side chain and has a weight-average molecular weight of 6,000 or more in view of the uneven distribution in the antireflection layer or a compound (a2) in which a crosslinking group is bonded to a low friction moiety directly or via a linking group and which has a weight-average molecular weight of less than 6,000 in view of the hardness of the outermost surface.

The compound (a1) is preferably a polymer, and the weight-average molecular weight of the compound (a1) is preferably 6,000 to 100,000 and more preferably 8,000 to 80,000.

The compound (a2) is preferably a monomer or an oligomer, and the weight-average molecular weight of the compound (a2) is preferably 900 to 6,000 and more preferably 1,300 to 5,000.

The weight-average molecular weight of the lubricant (a) is obtained by the same method as the weight-average molecular weight of the curable compound (b) described below.

In view of the chemical resistance and the durability, in the compound (a1), it is preferable that a crosslinking group is linked to a main chain via a C—C bond or a C—O bond.

Similarly, also in the compound (a2), in view of the chemical resistance and the durability, it is preferable that the low friction moiety and the crosslinking group are bonded via a C—C bond or a C—O bond.

It is preferable that the compound (a1) has a repeating unit having a low friction moiety in a side chain and a repeating unit having a crosslinking group in a side chain.

As the repeating unit having a crosslinking group in a side chain, the repeating units disclosed in [0028] to [0044] of JP2009-79126A may be referred.

It is preferable that the compound (a2) is
a compound having one group represented by Formula (M-2),
a compound having one group represented by Formula (M-3),
a compound having two groups represented by Formula (M-1),
a compound having two groups represented by Formula (M-2), or
a compound having two groups represented by Formula (M-3).

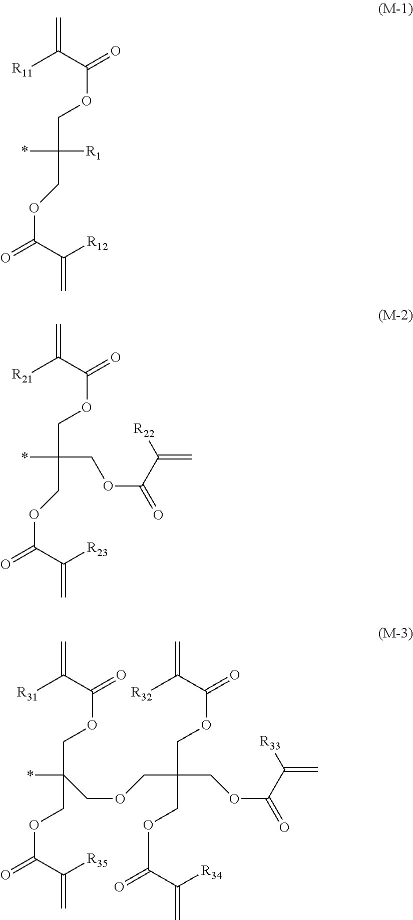

In Formula (M-1), R₁ represents a hydrogen atom, an alkyl group, an alkenyl group, an alkyloxy group, an alkenyloxy group, an alkyloxyalkyl group, or an alkenyloxyalkyl group. R₁₁ and R₁₂ each independently represent a hydrogen atom or a methyl group. * represents a bonding position.

In Formula (M-2), R₂₁ to R₂₃ each independently represent a hydrogen atom or a methyl group. * represents a bonding position.

In Formula (M-3), R₃₁ to R₃₅ each independently represent a hydrogen atom or a methyl group. * represents a bonding position.

In a case where the compound (a2) is a compound having one group represented by Formula (M-2), it is preferable that the group represented by Formula (M-2) which is a group having a crosslinking group is bonded to one terminal of a main chain including a low friction moiety directly or via a linking group.

In a case where the compound (a2) is a compound having one group represented by Formula (M-3), it is preferable that the group represented by Formula (M-3) which is the group having a crosslinking group is bonded to one terminal of the main chain including the low friction moiety directly or via a linking group.

In a case where the compound (a2) is a compound having two groups represented by Formula (M-1), it is preferable that the groups represented by Formula (M-1) which are groups having crosslinking groups are bonded to both terminals of the main chain including the low friction moiety directly or via linking groups. Here, two groups represented by Formula (M-1) may be identical to or different from each other.

In a case where the compound (a2) is a compound having two groups represented by Formula (M-2), it is preferable that the groups represented by Formula (M-2) which are groups having crosslinking groups are bonded to both terminals of the main chain including the low friction moiety directly or via linking groups. Here, two groups represented by Formula (M-2) may be identical to or different from each other.

In a case where the compound (a2) is a compound having two groups represented by Formula (M-3), it is preferable that the groups represented by Formula (M-3) which are groups having crosslinking groups are bonded to both terminals of the main chain including the low friction moiety directly or via linking groups. Here, two groups represented by Formula (M-3) may be identical to or different from each other.

In a case where the lubricant (a) has a low friction moiety including a fluorine atom, the moiety including a fluorine atom is preferably a fluoroalkyl group. For example, the lubricant (a) having a moiety including a fluorine atom may be represented by the structure provided in Formula (1), but the present invention is not limited thereto. According to the present invention, in the chemical formula, the hydrocarbon chain may be described by a simplified structural formula in which the symbols for carbon (C) and hydrogen (H) are omitted.

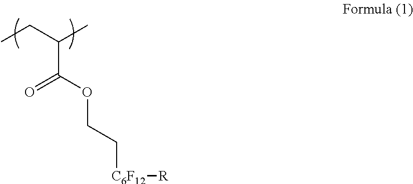

In Formula (1), R represents a hydrogen atom or a fluorine atom.

The structure of the siloxane bond in a case where the lubricant (a) has a low friction moiety including a siloxane bond is provided in Formula (P).

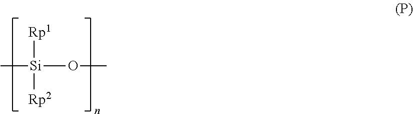

In Formula (P), Rp¹ and Rp² each independently represent a hydrogen atom, a monovalent hydrocarbon group, an alkoxy group, or an aryloxy group. n represents an integer of 2 or more.

Examples of the monovalent hydrocarbon group include an alkyl group, an aryl group, an alkenyl group, an alkynyl group, and an aralkyl group.

Rp¹ and Rp² each are preferably a hydrogen atom, a monovalent hydrocarbon group having 1 to 20 carbon atoms, an alkoxy group having 1 to 20 carbon atoms, or an aryloxy group having 6 to 20 carbon atoms, more preferably an alkyl group having 1 to 20 carbon atoms or an aryl group having 6 to 20 carbon atoms, even more preferably an alkyl group having 1 to 20 carbon atoms, and most preferably a methyl group.

n is preferably an integer of 6 to 100, n is more preferably an integer of 8 to 65, and n is most preferably an integer of 10 to 35.

As the moiety including a siloxane bond included in the lubricant (a), polydimethylsiloxane group or a polyether-modified dimethylsiloxane group are useful. According to the present invention, particularly, a polydimethylsiloxane group or a polyether-modified dimethylsiloxane group which has a repeating number n of 6 to 100 is more preferable, and n is more preferably 8 to 65 and most preferably 10 to 35.

In a case where the repeating number n of the polydimethylsiloxane group or the polyether-modified dimethylsiloxane group is 6 or more, the hydrophobicity is exhibited, the uneven distribution properties to the air interface becomes strong, the low friction moiety may be exposed on the surface, and the polydimethylsiloxane group or the polyether-modified dimethylsiloxane group is not too short as a low friction moiety, so that the sliding properties may be improved. In a case where the repeating number n is 100 or less, the uneven distribution is sufficient, the density of the crosslinking groups is not reduced, the hardness of the film obtained by crosslinking is increased, and the polydimethylsiloxane group or the polyether-modified dimethylsiloxane group effectively works for the scratch resistance test.

As the lubricant (a) having a moiety including a siloxane bond, a silicone-based polymer (the compound (A1)) and a silicone-based monomer or an oligomer (the compound (A2)) may be used. The compound (A1) and the compound (A2) are described below in detail.

<<Compound (A1)>>

The compound (A1) refers to a case where a low friction moiety is a moiety having a siloxane bond among the compounds (a1). That is, the compound (A1) is a compound (silicone-based polymer) having a moiety including a siloxane bond in a side chain and a crosslinking group and having a weight-average molecular weight of 6,000 or more. Specific examples of the compound (A1) are provided in Formula (2).

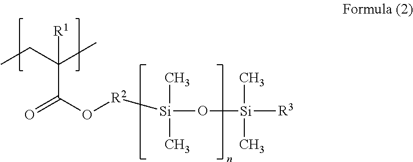

In Formula (2), R¹ represents a hydrogen atom or a methyl group, R² represents a divalent linking chain, R³ represents a hydrogen atom or a monovalent organic group, and n represents an integer of 5 to 100. In each repeating unit, R¹, R², and R³ may be identical to or different from each other.

In Formula (2), R² represents a divalent linking chain, and specific examples of a substituted or unsubstituted alkylene group, a substituted or unsubstituted arylene group, a substituted or unsubstituted alkylene group having a linking group (for example, an ether bond, an ester bond, and an amide bond) therein, and a substituted or unsubstituted arylene group having a linking group therein, a substituted or unsubstituted alkylene group, a substituted or unsubstituted arylene group, and an alkylene group having a linking group therein are preferable, an unsubstituted alkylene group, an unsubstituted arylene group, and an alkylene group having an ether bond or an ester bond therein are more preferable, and an unsubstituted alkylene group and an alkylene group having an ether bond or an ester bond therein are particularly preferable. Examples of the substituent include halogen, a hydroxyl group, a mercapto group, a carboxyl group, an epoxy group, an alkyl group, and an aryl group, and these substituents may be further substituted.

In Formula (2), n represents an integer of 5 to 100, preferably an integer of 7 to 65, and more preferably an integer of 9 to 35.

Among silicon-containing polymers (A) disclosed described in paragraphs [0012] to [0048] of JP2009-79126A, P-10 and P-12 to P-14 in which the acryl equivalent satisfies the range of the present invention are may be appropriately used as the lubricant (a). Specific examples of the lubricant (a) having a siloxane bond are provided below, but the present invention is not limited thereto. In the following specific examples, the number appended to parentheses of each monomer unit represents a molar ratio of each monomer unit in a polymer.

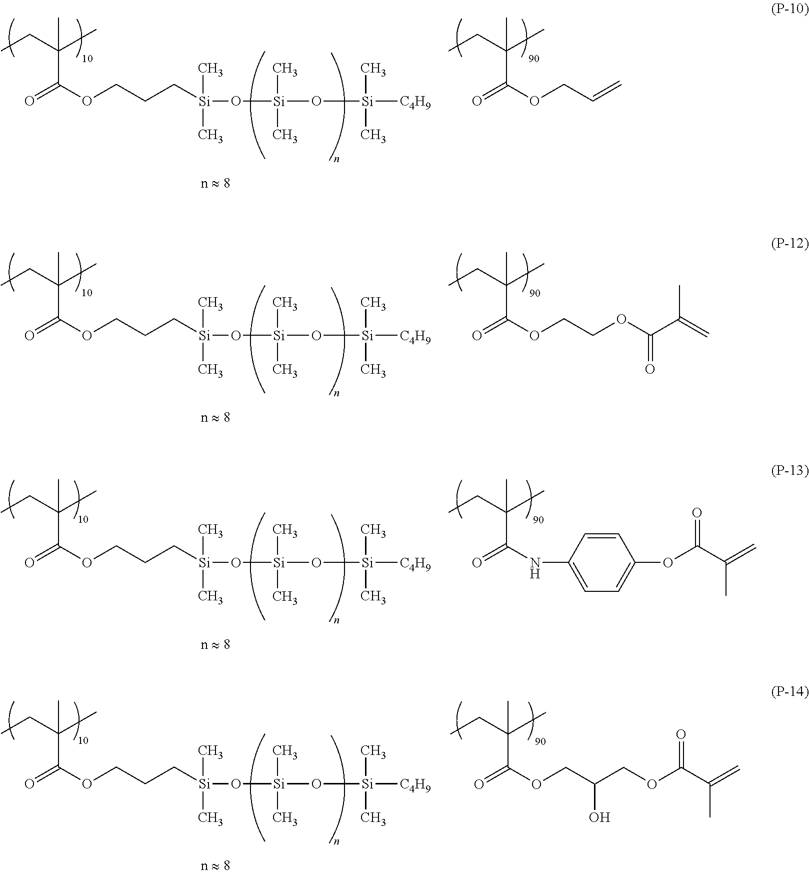

Examples of commercially available silicone-based polymers having a structure represented by Formula (2) include ACRIT 8SS-723 (manufactured by Taisei Fine Chemical Co., Ltd.) and ACRIT 8SS-1024 (manufactured by Taisei Fine Chemical Co., Ltd.).

<<Compound (A2)>>

The compound (A2) refers to a case where a low friction moiety is a moiety having a siloxane bond among the compounds (a2). That is, the compound (A2) is a compound (silicone-based monomer or oligomer) in which a crosslinking group is bonded to a moiety having a siloxane bond directly or via a linking group and which has a weight-average molecular weight of less than 6,000.

Examples of the silicone-based monomer or oligomer that is suitably used as the compound (A2) and that has a crosslinking group include a compound represented by Formula (4) and a compound represented by Formula (5), but the present invention is not limited thereto.

The compound represented by Formula (4) is a compound in which the group represented by Formula (M-3) which is the group having a crosslinking group is bonded to one terminal of the main chain including the low friction moiety via a linking group.

The compound represented by Formula (5) is a compound in which the group represented by Formula (M-2) which is a group having a crosslinking group is bonded to one terminal of a main chain including a low friction moiety via a linking group.

Formula (4)

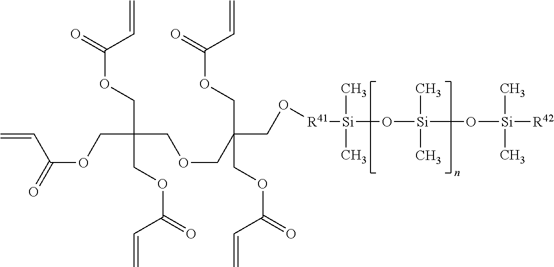

In Formula (4), R⁴¹ represents a divalent linking chain, R⁴² represents a hydrogen atom or a monovalent organic group, and n represents an integer of 4 to 100.

In Formula (4), R⁴¹ represents a divalent linking chain, and specific examples of a substituted or unsubstituted alkylene group, a substituted or unsubstituted arylene group, a substituted or unsubstituted alkylene group having a linking group (for example, an ether bond, an ester bond, and an amide bond) therein, and a substituted or unsubstituted arylene group having a linking group therein, a substituted or unsubstituted alkylene group, a substituted or unsubstituted arylene group, and an alkylene group having a linking group therein are preferable, an unsubstituted alkylene group, an unsubstituted arylene group, and an alkylene group having an ether bond or an ester bond therein are more preferable, and an unsubstituted alkylene group and an alkylene group having an ether bond or an ester bond therein are particularly preferable. Examples of the substituent include halogen, a hydroxyl group, a mercapto group, a carboxyl group, an epoxy group, an alkyl group, and an aryl group, and these substituents may be further substituted.

R⁴¹ in Formula (4) is preferably an unsubstituted alkylene group having an ether bond therein, more preferably *(CH₂)₃*.

R⁴² in Formula (4) represents a hydrogen atom or a monovalent organic group, and is preferably a hydrogen atom and a monovalent hydrocarbon group having 1 to 20 carbon atoms.

n in Formula (4) represents an integer of 4 to 100, preferably an integer of 6 to 65, and more preferably an integer of 8 to 35.

Specific examples of the compound represented by Formula (4) include the compounds (S-1) and (S-2). However, the present invention is not limited thereto.

Compound (S-1): Compound in Formula (4), in which n is 10, R⁴¹ is —(CH₂)₃—, and R⁴² is CH₃.

Compound (S-2): Compound in Formula (4) in which n is 21, R⁴¹ is —(CH₂)₃—, and R⁴² is CH₃.

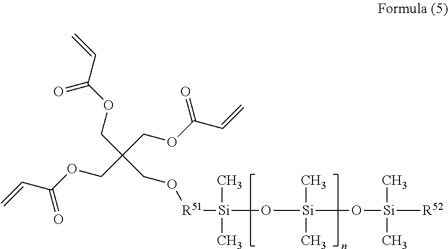

In Formula (5). R⁵¹ represents a divalent linking chain, R⁵² represents a hydrogen atom or a monovalent organic group, and n represents an integer of 2 to 100.

Specific examples and preferable ranges of R⁵¹ and R⁵² in Formula (5) are respectively the same as those of R⁴¹ and R⁴² in Formula (4).

The preferable range of n in Formula (5) is the same n in Formula (4).

Specific examples of the compound represented by Formula (5) include the compound (S-3). However, the present invention is not limited thereto.

Compound (S-3): Compound in Formula (5), in which n is 10, R⁵¹ is —(CH₂)₃—, and R⁵² is CH₃.

A compound (S-9) in Formula (4) which is a compound in which n is 10, R⁴¹ is —CONH(CH₂)₃—, and R⁴² is —CH₃ is also preferable.

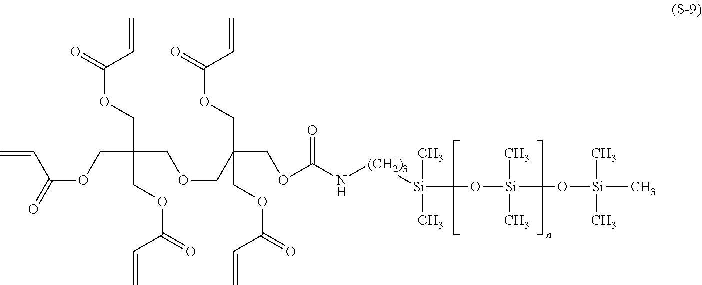

A compound (S-10) in Formula (5) which is a compound in which n is 10, R⁵¹ is —CONH(CH₂)₃—, and R⁵² is —CH₃ is also preferable.

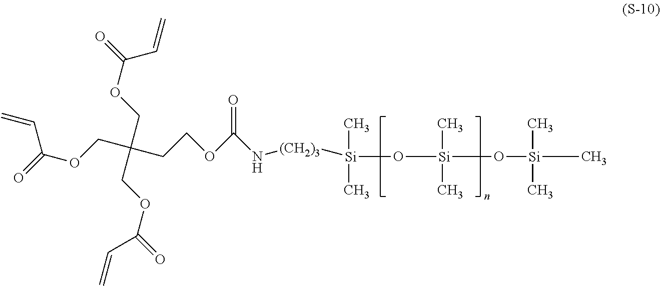

Examples of the silicone-based monomer or oligomer that is suitably used as the compound (A2) and that has a crosslinking group include a compound represented by Formula (6) and a compound represented by Formula (7) in addition to the compound represented by Formula (4) and the compound represented by Formula (5), but the present invention is not limited thereto.

The compound represented by Formula (6) is a compound in which the groups represented by Formula (M-3) which are the groups having a crosslinking group are bonded to both terminals of the main chain including the low friction moiety via linking groups.

The compound represented by Formula (6) is a compound in which the group represented by Formula (M-2) which is the group having the crosslinking group is bonded to one terminal of the main chain including a low friction moiety via a linking group, and the group represented by Formula (M-2) which is the group having the crosslinking group is bonded to the other terminal of the main chain including a low friction moiety via a linking group.

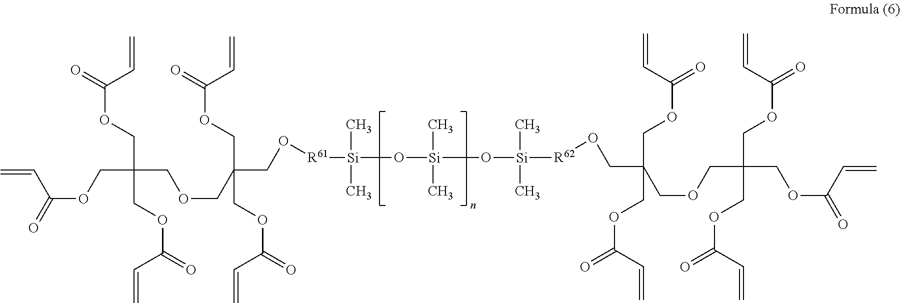

R⁶¹ and R⁶² in Formula (6) each independently represent a divalent linking chain, and n represents an integer of 4 to 100.

Specific examples and preferable ranges of R⁶¹ and R⁶² in Formula (6) are respectively the same as those of R⁴¹ in Formula (4).

The preferable range of n in Formula (6) is the same n in Formula (4).

Specific examples of the compound represented by Formula (6) include compounds (S-4) to (S-6). However, the present invention is not limited thereto.

Compound (S-4): Compound in Formula (6) in which n is 9, and R⁶¹ and R⁶² are —(CH₂)₃—.

Compound (S-5): Compound in Formula (6) in which n is 20, and R⁶¹ and R⁶² are —(CH₂)₃—.

Compound (S-6): Compound in Formula (6) in which n is 40, and R⁶¹ and R⁶² are —(CH₂)₃—.

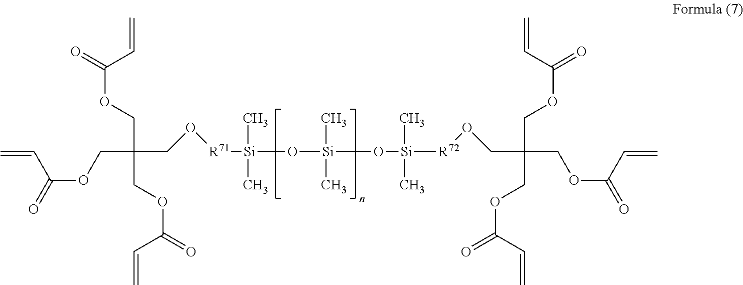

In Formula (7). R⁷¹ and R⁷² each independently represent a divalent linking chain, and n represents an integer of 2 to 100.

Specific examples and preferable ranges of R⁷¹ and R⁷² in Formula (7) are respectively the same as those of R⁴¹ in Formula (4).

The preferable range of n in Formula (7) is the same n in Formula (4).

Specific examples of the compound represented by Formula (7) include compounds (S-7) to (S-8). However, the present invention is not limited thereto.

Compound (S-7): Compound in Formula (7) in which n is 20, and R⁷¹ and R⁷² are —(CH₂)₃—.

Compound (S-8): Compound in Formula (7) in which n is 40, and R⁷¹ and R⁷² are —(CH₂)₃—.

A compound (S-11) which is a compound in Formula (6) in which n is 10, and R⁶¹ and R⁶² are —CONH(CH₂)₃— is also preferable.

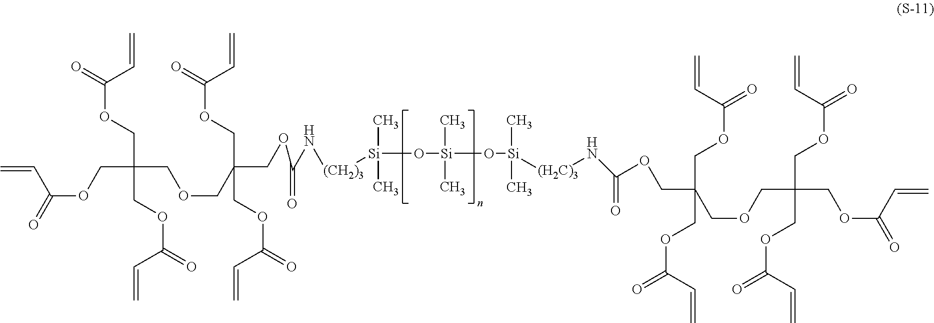

A compound (S-12) which is a compound in Formula (7) in which n is 10, and R^{7′} and R⁷² are —CONH(CH₂)₃— is also preferable.

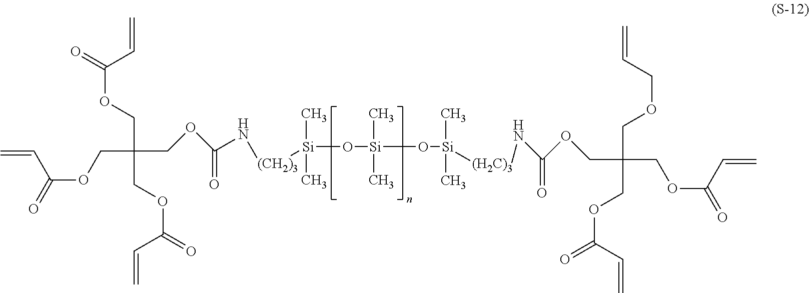

<Curable Compound (b)>

The curable compound (b) is a compound having three or more crosslinking groups in at least one molecule, having a crosslinking group equivalent of 450 or less, and not having both of a fluorine atom and a siloxane bond.

Specific examples and preferable range of the crosslinking group of the curable compound (b) are respectively the same as those of the crosslinking group of the lubricant (a).

The crosslinking group equivalent of the curable compound (b) is a value obtained by dividing a molecular weight of the curable compound (b) by the number of crosslinking groups included in the curable compound (b), and is 450 or less, more preferably 350 or less, and even more preferably 250 or less in view of film hardness.

As the curable compound (b), at least one kind of the compounds having a radical reactive group is preferably used.

Examples of the radical reactive group include a group (for example, a (meth)acryloyl group, a (meth)acrylamide group, a (meth)acrylonitrile group, an allyl group, a vinyl group, a styrene structure, a vinyl ether structure, and an acetylene structure) having an addition polymerizable unsaturated bond, —SH, —PH, SiH, —GeH, and a disulfide structure.

As the curable compound (b), at least one of a compound having a polymerizable functional group (polymerizable carbon-carbon unsaturated double bond) such as (meth)acryloyl group, a vinyl group, a styryl group, and an allyl group is preferably used. Among these, at least one of a compound having a (meth)acryloyl group and —C(O)OCH═CH₂ is preferably used, at least one of a compound having a (meth)acryloyl group is more preferably used, and at least one of a compound having two or more (meth)acryloyl groups in one molecule is even more preferably used.

As the curable compound (b), one kind of compounds may be used singly or two or more kinds of the compound may be used in combination.

Particularly, in a case where the antireflection film of the present invention uses a substrate with a hard coat layer as the substrate, at least two curable compounds are used as the curable compound (b). At least one of the curable compounds is a compound having a radical reactive group, at least the other one is a compound that permeates the substrate in a step (3) in a method of manufacturing an antireflection film. A compound not having a radical reactive group and having a reactive group other than a radical reactive group is preferable.

Examples of the curable compound (b) include the curable compounds (b-1) to (b-3), it is preferable to use two of these in combination, and it is more preferable to use three of these in combination.

Curable compound (b-1): Compound having a molecular weight of 400 or more and having a radical reactive group

Curable compound (b-2): Silane coupling agent having a radical reactive group

Curable compound (b-3): Compound having a molecular weight of less than 400, having not a radical reactive group, and having a reactive group other than a radical reactive group or compound having a molecular weight of less than 300 and being volatilized during heating

The molecular weight of the curable compound (b) is obtained from a structural formula in a case of being primarily obtained from the structural formula of the curable compound. In a case where the molecular weight may not be primarily obtained from the structural formula, for example, the curable compound has distribution like a polymer compound, the molecular weight is a weight-average molecular weight measured by using the gel permeation chromatography.

The weight-average molecular weight according to the present invention is a value measured in the following conditions by the gel permeation chromatography (GPC).

| | |
|---|---|
| [Solvent] | Tetrahydrofuran |
| [Name of device] | TOSOH HLC-8220GPC |
| [Column] | Three items of TOSOH TSKgel Super HZM-H |
| | (4.6 mm × 15 cm) are connected to each other |
| | to be used. |
| [Column temperature] | 25° C. |
| [Sample concentration] | 0.1 mass % |
| [Flow rate] | 0.35 ml/min |
| [Calibration Curve] | A calibration curve with seven samples of TSK |
| | standard polystyrene manufactured by TOSOH |
| | Corporation weight-average molecular weight |
| | (Mw) = 2,800,000 to 1,050 is used. |

<<Curable Compound (b-1)>>

A curable compound (b-1) is a compound having a molecular weight of 400 or greater and having a radical reactive group.

The curable compound (b-1) is preferably a compound that hardly permeates the substrate.

The molecular weight of the curable compound (b-1) is preferably 400 to 100,000 and more preferably 1,000 to 50,000.

In the curable compound (b-1), a functional group equivalent represented by (molecular weight/radical reactive group amount) is preferably 450 or less, more preferably 400 or less, and even more preferably 350 or less.

It is preferable that the curable compound (b-1) does not have a hydrolyzable silane coupling group (that is, it is not a silane coupling agent) represented by an alkoxysilyl group.

Examples of the curable compound (b-1) include (meth)acrylic acid diesters of alkylene glycol. (meth)acrylic acid diesters of polyoxyalkylene glycol, (meth)acrylic acid diesters of polyhydric alcohol, (meth)acrylic acid diesters of an ethylene oxide or propylene oxide adduct, epoxy (meth)acrylates, urethane (meth)acrylates, and polyester (meth)acrylates.

Specific examples of the curable compound (b-1) include an esterification product of polyol and (meth)acrylic acid such as KAYARAD DPHA, KAYARAD DPHA-2C, KAYARAD PET-30, KAYARAD TMPTA, KAYARAD TPA-320. KAYARAD TPA-330, KAYARAD RP-1040, KAYARAD T-1420, KAYARAD D-310, KAYARAD DPCA-20, KAYARAD DPCA-30, KAYARAD DPCA-60, and KAYARAD GPO-303 (manufactured by Nippon Kayaku Co., Ltd.), NK ESTER A-TMPT, A-TMMT, A-TMM3, A-TMM3L, and A-9550 (manufactured by Shin Nakamura Chemical Co., Ltd.), and V#3PA, V#400, V#36095D, V#1000, V#1080, and VISCOAT#802 (manufactured by Osaka Organic Chemical Industry Ltd.), and a dendrimer-type polyfunctional acrylate such as SIRIUS-501 and SUBARU-501 (manufactured by Osaka Organic Chemical Industry Ltd.). A trifunctional or higher functional urethane acrylate compound such as SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B. SHIKOH UV-7461TE, SHIKOH UV-3000B, SHIKOH UV-3200B, SHIKOH UV-3210EA, SHIKOH UV-3310EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, SHIKOH UV-2250EA, and SHIKOH UV-2750B (manufactured by Nippon Synthetic Chem Industry Co., Ltd.), UL-503LN (manufactured by Kyoeisha Chemical Co., Ltd.), UNIDIC 17-806, UNIDIC 17-813, UNIDIC V-4030, and UNIDIC V-4000BA (manufactured by DIC Corporation), EB-1290K, EB-220, EB-5129, EB-1830, and EB-4858 (manufactured by Daicel-UCB Corporation), HIGH-COAP AU-2010 and UNIDIC AU-2020 (manufactured by Tokushiki Co., Ltd.), ARONIX M-1960 (manufactured by Toagosei Co., Ltd.), and ARTRESIN UN-3320HA, UN-3320HC, UN-3320HS, and UN-904 (manufactured by Negami Chemical Industrial Co., Ltd.), and NK OLIGO U-4HA and U-15HA (manufactured by Shin Nakamura Chemical Co., Ltd.) and a trifunctional or higher functional polyester compound such as ARONIX M-8100, M-8030, and M-9050 (manufactured by Toagosei Co., Ltd.), and KRM-8307 (manufactured by Daicel Cytec Co., Ltd.) can be suitably used.

<<Curable Compound (b-2)>>

The curable compound (b-2) is a silane coupling agent having a radical reactive group.

The molecular weight of the curable compound (b-2) is preferably 100 to 5,000 and more preferably 200 to 2,000.

The curable compound (b-2) is preferably a compound that hardly permeates the substrate.

In the curable compound (b-2), a functional group equivalent represented by (molecular weight/radical reactive group amount) is preferably 450 or less, more preferably 400 or less, and even more preferably 350 or less.

Specific examples of the curable compound (b-2) include 3-(meth)acryloxypropyltrimethoxysilane, 3-(meth)acryloxypropylmethyldimethoxysilane, 3-(meth)acryloxypropyldimethylmethoxysilane, 3-(meth)acryloxypropylmethyldiethoxysilane, 3-(meth)acryloxypropyl triethoxysilane, 2-(meth)acryloxyethyltrimethoxysilane, 2-(meth)acryloxyethyltriethoxysilane, 4-(meth)acryloxybutyltrimethoxysilane, and 4-(meth)acryloxybutyltriethoxysilane. Specifically, KBM-503 and KBM-5103 (manufactured by Shin-Etsu Chemical Co., Ltd.) or silane coupling agents X-12-1048, X-12-1049, and X-12-1050 (manufactured by Shin-Etsu Chemical Co., Ltd.) disclosed in JP2014-123091A and the like can be used.

An acryloyl group-containing trimethoxysilane represented by Formula (10) may also be preferably used.

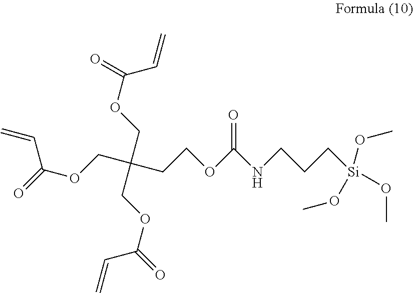 [SMILES: C=CC(=O)OCC(CCOC(=O)NCCC[Si](OC)(OC)OC)(COC(=O)C=C)COC(=O)C=C]

<<Curable Compound (b-3)>>

A curable compound (b-3) is a compound having a molecular weight of 400) or less, not having a radical reactive group, and having a reactive group other than a radical reactive group.

The curable compound (b-3) is preferably a compound that hardly permeates the substrate at 25° C. and easily permeates the substrate during heating.

The reactive group other than a radical reactive group included in the curable compound (b-3) is preferably a group that reacts with a compound forming the substrate (a functional layer in a case where the substrate has a functional layer such as a hard coat layer), and examples thereof include an epoxy group, an amino group, a boronic acid group, a boronic acid ester group, an oxiranyl group, an oxetanyl group, a hydroxyl group, a carboxyl group, and an isocyanate group.

The molecular weight of the curable compound (b-3) is preferably 100 or greater and less than 400 and more preferably 200 to 300.

The curable compound (b-3) preferably has two or more reactive groups other than the radical reactive group.

Specific examples of the curable compound (b-3) include CELOXIDE 2021P, CELOXIDE 2081, EPOLEAD GT-301, EPOLEAD GT-401, and EHPE3150CE (above are manufactured by Daicel Corporation), OXT-121, OXT-221, OX-SQ, and PNOX-1009 (above, Toagosei Co., Ltd.), and KBM-303, KBM-402, KBM-403, KBE-402, KBE-403, and KBM-4803 (above, manufactured by Shin-Etsu Chemical Co., Ltd.).

The content of the curable compound (b) is preferably 50 to 98 mass %, more preferably 55 to 95 mass %, even more preferably 60 to 90 mass % with respect to the total solid content in the curable composition.

<Photopolymerization Initiator (c)>

The area (S) of the antireflection layer of the present invention includes a cured product of the curable composition including the lubricant (a), the curable compound (b), and the photopolymerization initiator (c).

Examples of the photopolymerization initiator (c) include acetophenones, benzoins, benzophenones, phosphine oxides, ketals, anthraquinones, thioxanthones, an azo compound, peroxides, 2,3-dialkyldione compounds, disulfide compounds, fluoroamine compounds, aromatic sulfoniums, lophine dimers, onium salts, borate salts, active esters, active halogens, an inorganic complex, and coumarins. Specific examples, preferable aspects, commercially available products, and the like of the photopolymerization initiator (c) are disclosed in paragraphs [0133] to [0151] of JP2009-098658A, and may be suitably used in the present invention in the in the same manner.

Various examples are disclosed in “Newest UV curing technology” {Technical Information Institute Co. Ltd.} (1991), page 159 and “Ultraviolet Curing System” written by Kiyomi KATO (published in 1989 by The Integrated Technology Center), pages 65 to 148, and are useful for the present invention as the photopolymerization initiator (c).

In order to set the content of the photopolymerization initiator to be sufficiently large for polymerizing the polymerizable compound included in the curable composition (antireflection layer forming composition) and sufficiently small so as not to increase the starting point too much, the content of the photopolymerization initiator (c) is preferably 0.5 to 8 mass % and more preferably 1 to 5 mass % with respect to the total solid content in the antireflection layer forming composition.

The area (S) of the antireflection layer of the present invention includes a cured product of the curable composition including the lubricant (a), the curable compound (b), and the photopolymerization initiator (c), but the curable composition may contain other components.

The antireflection film of the present invention has an area having a content of the lubricant (a) of 51% or more in a material distribution in a cross section direction of the area (S).

In a case where a maximum content of a fluorine atom and silicone (siloxane bond) that are present in any area (S) from an outermost surface of the antireflection layer, opposite to the surface of the antireflection layer at the substrate side, to 20 nm is set as X, and a total amount of a fluorine atom and silicone (siloxane bond) in a film in a case where the film is obtained by curing the lubricant (a) singly is set as Y, the content of the lubricant (a) is set as a value (unit: %) represented by 100*(X/Y). The material distribution in the cross section direction of the antireflection layer is detected as the material distribution including the lubricant (a) in a case where the film is cut with a microtome and the cross section is analyzed with a time-of-flight secondary ion mass spectrometer (TOF-SIMS), and the film thickness of this area may be also measured from the cross-sectional information of the TOF-SIMS in the same manner.

The antireflection film of the present invention has an area in which the content of the lubricant (a) in the area (S) is 51% or more, preferably has an area in which the content thereof is more than 55% and less than 100%, more preferably has an area in which the content thereof is 60% or more, and even more preferably an area in which the content thereof is 70% or more.

In a case where the antireflection film of the present invention has an area in which the content of the lubricant (a) in the area (S) is 51% or more, the lubricant (a) is not distributed to the inside of the film of the antireflection layer (that is, is unevenly distributed in the vicinity of the outermost surface of the antireflection layer), and the sliding properties and the film hardness may be improved.

The total content of the fluorine atom and the silicone (siloxane bond) may be measured by a proportion of F⁻ fragment or Si₂C₅H₁₅O⁺ fragment measured in a time-of-flight secondary ion mass spectrometer (TOF-SIMS) or may be measured by a proportion of F/C or Si/C measured in the X-ray Photoelectron Spectroscopy (XPS) analysis in which the incidence angle is appropriately adjusted. In a case where a single film obtained by curing only the lubricant (a) is measured by TOF-SIMS or XPS, the content may be defined as 100%, and in a case where the antireflection film of the present invention is measured in the same measuring method as the single film, the content in the antireflection film is determined.

The film thickness of the antireflection layer of the antireflection film of the present invention is preferably 50 to 200 nm and more preferably 60 to 190 nm.

(Substrate)

The substrate is not particularly limited, as long as the substrate is a substrate having light transmitting properties that is generally used as a substrate of an antireflection film, but a plastic substrate or a glass substrate is preferable.

As the plastic substrate, various kinds thereof may be used. Examples thereof include a substrate containing a cellulose-based resin; cellulose acylate (triacetate cellulose, diacetyl cellulose, and acetate butyrate cellulose) and the like; a polyester resin: polyethylene terephthalate and the like, a (meth)acrylic resin, a polyurethane-based resin, polycarbonate, polystyrene, an olefin-based resin, and the like. A substrate containing cellulose acylate, polyethylene terephthalate, or a (meth)acrylic resin is preferable, a substrate containing cellulose acylate is more preferable, and a cellulose acylate film is particularly preferable. As the cellulose acylate, substrates and the like disclosed in JP2012-093723A may be preferably used.

The thickness of the substrate is usually about 10 μm to 1,000 μm. However, in view of satisfactory handleability, high light transmitting properties, and sufficient hardness, the thickness is preferably 20 μm to 200 μm and more preferably 25 μm to 100 μm. As the light transmitting properties of the substrate, it is preferable that a transmittance of visible light (preferably an average transmittance at a wavelength of 400 nm to 750 nm) is preferably 80% or greater and more preferably 90% or greater.

With respect to the antireflection film of the present invention, in a case where the reflectance of the antireflection film after the outermost surface of the antireflection layer, opposite to the surface of the antireflection layer at the substrate side, is rubbed by 10 round trips with steel wool in the condition of the load of 200 g is set as R_{A}, and the reflectance of the antireflection film before being rubbed with steel wool is set as R₀, the reflectance change represented by R_{A}-R₀ is preferably 0.25% or less, more preferably 0.20% or less, and even more preferably 0.15% or less.

However, the reflectance R_{A} refers to a reflectance in a case where the rubbing speed of 13 cm/sec, a load of 200 g/cm², a contact area between the steel wool and the antireflection film surface of 1 cm×1 cm, and the film surface is rubbed by 10 round trips with steel wool.

<Particle (d)>

The antireflection layer of the antireflection film of the present invention preferably has the particle (d) having an average primary particle diameter of 250 nm or less.

Examples of the particle (d) include a metal oxide particle, resin particle, and an organic-inorganic hybrid particle having a core of a metal oxide particle and a shell of a resin. In view of excellent film hardness, the metal oxide particle is preferable.

Examples of the metal oxide particle include a silica particle, a titania particle, a zirconia particle, and an antimony pentoxide particle. Since the refractive index is close to many resins, haze is hardly generated and the moth eye structure is easily formed. Therefore, a silica particle is preferable.

Examples of the resin particle include a polymethyl methacrylate particle, a polystyrene particle, and a melamine particle.

In view of causing particles to be arranged to form a moth eye structure, an average primary particle diameter of the particles (d) is more preferably 150 nm to 250 nm and even more preferably 170 nm to 220 nm.

Only one kind of the particle (d) may be used singly, or two or more kinds of particles having different average primary particle diameters may be used.

The average primary particle diameter of the particle (d) refers to the cumulative 50% particle diameter of the volume average particle diameter.

More specifically, particles are added to ethanol so as to have a content of 35 mass %, are dispersed for 10 minutes or longer by ultrasonic waves to prepare a dispersion liquid of the particles, and the dispersion liquid can be measured by electron micrograph. A scanning electron microscope (SEM) image is captured by adding dropwise the dispersion liquid, the diameter of each of the 100 primary particles is measured to calculate the volume, and the cumulative 50% particle diameter can be set as the average primary particle diameter. In a case where the particle is not spherical, the average value of the long diameter and the short diameter is regarded as the diameter of the primary particle.

A shape of the particle (d) is most preferably a spherical shape, but may be a shape other than a spherical shape such as an amorphous shape. The particle may be any one of crystalline and amorphous.

As the particle (d), a surface-treated inorganic fine particle is preferably used for improving the dispersibility in the coating liquid, improving the film hardness, and preventing aggregation. Specific examples and preferable examples of the surface treatment method are the same as those described in [0119] to [0147] of JP2007-298974A.

Particularly, in view of providing the binding properties to the resin and improving the film hardness, it is preferable that the surface of the particle is surface-modified with a compound having a functional group having reactivity with an unsaturated double bond and the particle surface, and an unsaturated double bond is applied to the particle surface.

Specific examples of the particle having an average primary particle diameter of 150 nm to 250 nm include SEAHOSTAR KE-P20 (amorphous silica manufactured by Nippon Shokubai Co., Ltd. having an average primary particle diameter of 200 nm), EPOSTAR S (a melamine/formaldehyde condensate manufactured by Nippon Shokubai Co., Ltd. having an average primary particle diameter of 200 nm), EPOSTAR MA-MX100W (a polymethylmethacrylate (PMMA)-based crosslinked product manufactured by Nippon Shokubai Co., Ltd. having an average primary particle diameter of 175 nm), and the like can be preferably used.

Since the amount of hydroxyl groups on the surface is moderately large and the particle is hard, the particle (d) is particularly preferably a calcined silica particle.

The calcined silica particle can be manufactured by a well-known technique of hydrolyzing and condensing a hydrolyzable silicon compound in an organic solvent including water and a catalyst to obtain a silica particle and calcining the silica particle, and, for example, JP2003-176121A and JP2008-137854A can be referred to.

The silicon compound as a raw material for manufacturing the calcined silica particle is not particularly limited, and examples thereof include a chlorosilane compound such as tetrachlorosilane, methyltrichlorosilane, phenyltrichlorosilane, dimethyldi chlorosilane, diphenyldichlorosilane, methyl vinyl dichlorosilane, trimethylchlorosilane, and methyl diphenylchlorosilane; an alkoxysilane compound such as tetramethoxysilane, tetraethoxysilane, tetraisopropoxysilane, tetrabutoxysilane, methyltrimethoxysilane, methyltriethoxysilane, trimethoxyvinylsilane, triethoxyvinylsilane, 3-glycidoxypropyltrimethoxysilane, 3-chloropropyltrimethoxysilane, 3-mercaptopropyltrimethoxysilane, 3-(2-aminoethylamino) propyltrimethoxysilane, phenyltrimethoxysilane, phenyltriethoxysilane, dimethyl dimethoxysilane, dimethyl diethoxysilane, 3-glycidoxypropylmethyldimethoxysilane, 3-glycidoxypropylmethyldiethoxysilane, 3-chloropropylmethyldimethoxysilane, diphenyldimethoxysilane, diphenyldiethoxysilane, dimethoxydiethoxysilane, trimethylmethoxysilane, and trimethylethoxysilane: an acyloxysilane compound such as tetraacetoxysilane, methyl triacetoxysilane, phenyl triacetoxysilane, dimethyl diacetoxysilane, diphenyl diacetoxysilane, and trimethylacetoxysilane; and a silanol compound such as dimethylsilanediol, diphenylsilanediol, and trimethylsilanol. Among the exemplary silane compounds, an alkoxysilane compound is particularly preferable, since alkoxysilane compound can be obtained more easily and halogen atoms as impurities in the obtained calcined silica particle are not included. As a preferred aspect of the calcined silica particle according to the present invention, it is preferable that the content of halogen atoms is substantially 0% o, and halogen atoms are not detected.

The calcining temperature is not particularly limited, but is preferably 800° C. to 1,300° C. and more preferably 1,000° C. to 1,200° C.

The content of the particle (d) in the antireflection layer is preferably 0.10 to 0.30 g/m², more preferably 0.14 to 0.24 g/m², and even more preferably 0.16 to 0.20 g/m².

[Antireflection Film Having Uneven Shape Formed by Particle (d) on Outermost Surface of Antireflection Layer]

As one preferable aspect of the antireflection film of the present invention, an antireflection film having an uneven shape formed by the particle (d) on an outermost surface of the antireflection layer is exemplified. FIG. 4 is a schematic cross sectional view illustrating an example of the antireflection film of the present invention according to this aspect.

The uneven shape formed by the particle (d) is preferably a moth eye structure.

In a case where the antireflection layer is the particle (d), the particle (d) projects from the surface opposite to the surface on the substrate side of a flat portion (film) including a resin formed by curing the lubricant (a), the curable compound (b), and the like to become a protrusion, a portion between the particles (d) becomes a recessed part, and it is preferable to form an uneven shape on the surface of the antireflection layer. It is preferable that a cured product obtained by curing the lubricant (a), the curable compound (b), and the like becomes a coating film so as to coat the surface of a projecting portion in which the particle (d) projects from the flat portion (film) including the resin formed by curing the lubricant (a) and the curable compound (b).

Also in this aspect, the antireflection layer of the antireflection film of the present invention has an area in which the content of the lubricant (a) in the material distribution of the cross section direction of the area (S) is 51% or more in the area (S) having a thickness of 20 nm or less in the direction from the outermost surface of the antireflection layer, opposite to a surface of the antireflection layer at the substrate side, toward the substrate and including a cured product of the curable composition including the lubricant (a), the curable compound (b), and the photopolymerization initiator (c). It is preferable that the coating film that covers the surface of the projecting portion of the particle (d) is the area (S) having a thickness of 20 nm or less and has an area in which the content of the lubricant (a) in the area (S) is 51% or more.

(Moth Eye Structure)

The moth eye structure refers to a surface obtained by processing of a substance (material) for suppressing reflection of light and a structure of having a periodic microstructure pattern. Particularly, in a case of having the purpose of suppressing reflection of visible light, the moth eye structure refers to a structure having a microstructure pattern with a period of less than 780 nm. It is preferable that the period of the microstructure pattern is less than 380 nm, the tint of reflected light becomes small. It is preferable that the period of the uneven shape of the moth eye structure is 100 nm or greater, light having a wavelength of 380 nm can recognize a microstructure pattern and is excellent in antireflection properties. Whether the moth eye structure is present can be checked by observing the surface shape with a scanning electron microscope (SEM), an atomic force microscope (AFM) or the like, and checking whether the microstructure pattern is formed.

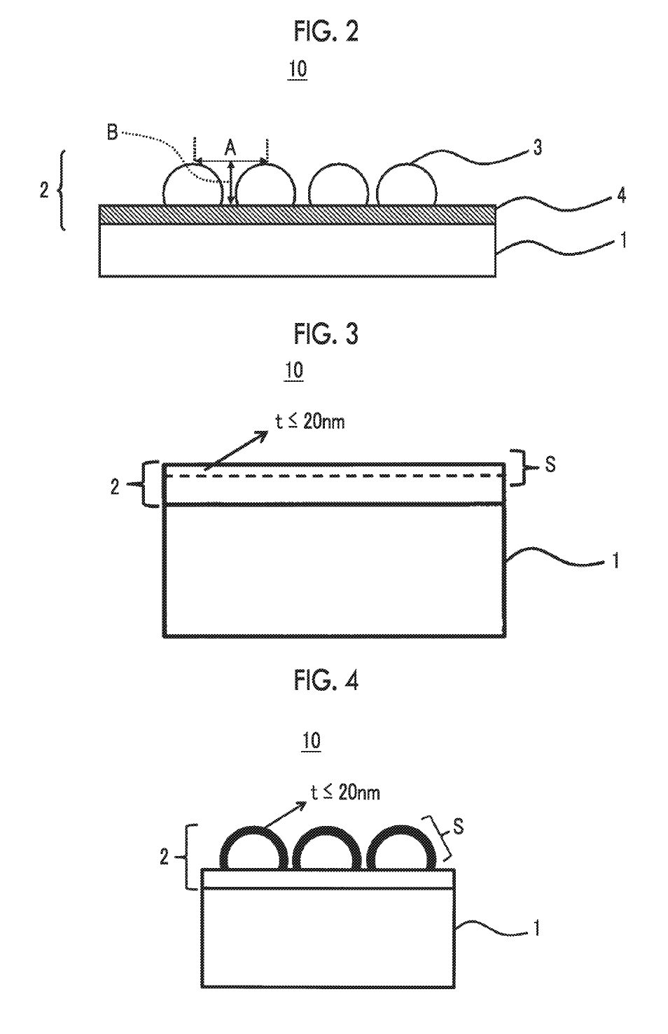

An example of a preferable embodiment of an antireflection film of the present invention is illustrated in FIG. 2.

An antireflection film 10 in FIG. 2 has a substrate 1 and an antireflection layer 2. The antireflection layer 2 has a moth eye structure formed of an uneven shape formed of a particle 3 having an average primary particle diameter, for example, of 150 nm to 250 nm on a surface on the opposite side of a substrate 1.

The antireflection layer 2 includes the particle 3 having an average primary particle diameter of 150 nm to 250 nm and a resin 4.

Though not illustrated in FIG. 2, other layers may be provided between the substrate and the antireflection layer, and it is preferable to provide a hard coat layer.

Materials of the substrate, the antireflection layer, and the hard coat layer in the antireflection film are the same as in the method of manufacturing the antireflection film according to the present invention.

In the uneven shape of the antireflection layer of the antireflection film, B/A which is the ratio of a distance A between the peaks of the adjacent protrusions and a distance B between the center between the peaks of the adjacent protrusions and the recessed part is preferably 0.5 or greater, more preferably 0.6 or greater, and even more preferably 0.7 or greater. In a case where B/A is 0.5 or greater, the refractive index gradient layer in which the depth of the recessed part is greater than the distance between the protrusions and the refractive index gradually changes from the air to the inside of the antireflection layer can be formed, and thus the reflectance can be further reduced.

B/A can be controlled by the volume ratio of the resin and the particle in the antireflection layer after curing. Therefore, it is important to appropriately design the formulation ratio of the resin and the particle. In a case where the resin permeates the substrate in the step of preparing the moth eye structure or volatilizes, the volume ratio of the resin and the particle in the antireflection layer becomes different from the formulation ratio in the antireflection layer forming composition, and thus the matching with the substrate is appropriately set.

It is preferable that the particles for forming protrusions are spread evenly at an appropriate filling rate. In view of the above, the content of the particle for forming the protrusions is preferably adjusted such that the particles are even over the entire antireflection layer. The filling rate can be measured as the area occupation ratio (particle occupation ratio) of the particle located most surface side in a case of observing the particle for forming the protrusions from the surface by SEM or the like, and is 25% to 84%, preferably 25% to 70%, and more preferably 30% to 65%.

In the antireflection layer in the present invention, it is preferable that a plurality of particles (d) are not present in a direction orthogonal to the surface of the substrate (that is, no particle (d) overlapping each other is present in a direction orthogonal to the surface of the substrate), since the reflectance and the haze are low.

[Method of Manufacturing Antireflection Film]

The method of manufacturing the antireflection film of the present invention is not particularly limited, and the method of manufacturing the antireflection film in an aspect in which the antireflection layer contains the particle (d) is preferably a method of manufacturing an antireflection film, including, in order:

a step (1) of coating a substrate with a composition including the lubricant (a), the curable compound (b), the photopolymerization initiator (c), the particle (d), and a solvent, and volatilizing the solvent, to prove a layer (A) in which a thickness of a portion in which the particle (d) is not present is a thickness of 0.8 times or more of the average primary particle diameter of the particle (d);

a step (2) of curing a portion of the curable compound (b) in the layer (A) and obtaining a cured compound (bc);

a step (3) of permeating a portion of a compound selected from the group consisting of the curable compound (b) and the compound (bc) in the layer (A) to the substrate by heating or performing volatilization so as to form an uneven shape including the particle (d) on a surface opposite to the surface of the layer (A) on the substrate side; and

a step (4) of curing a compound selected from the group consisting of the curable compound (b) and the compound (bc) remaining in the layer (A) so as to form an antireflection layer.

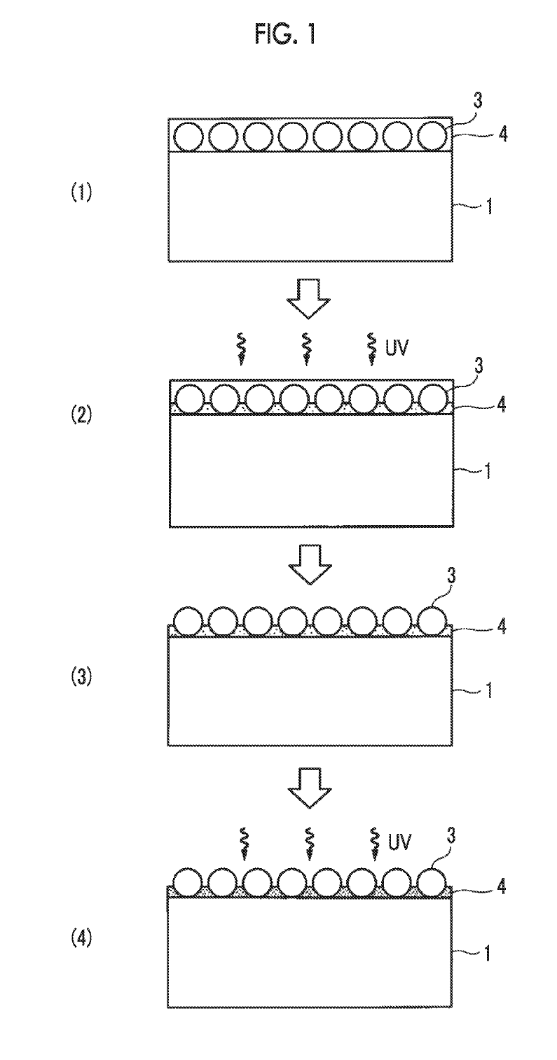

A schematic view illustrating an example of the method of manufacturing the antireflection film of the present invention is provided in FIG. 1.

[Step (1)]

As illustrated in (1) of FIG. 1, the step (1) is a step of coating a substrate (reference numeral 1 in FIG. 1) with the composition including the lubricant (a), the curable compound (b), the photopolymerization initiator (c), the particle (d) (reference numeral 3 in FIG. 1) having an average primary particle diameter of 250 nm or less, and a solvent, volatilizing the solvent, and providing the layer (A) (reference numeral 4 in FIG. 1) in which a thickness of a portion in which the particle (d) is not present is a thickness of 0.8 times or more of the average primary particle diameter of the particle (d).

The lubricant (a), the curable compound (b), the photopolymerization initiator (c), and the particle (d) which are used in the step (1) are as described above.

<Solvent>

In view of improving the dispersibility, it is preferable to select a solvent having a polarity close to that of the particle (d). Specifically, for example, in a case where the particle (d) is a metal oxide particle, an alcohol-based solvent is preferable, and examples thereof include methanol, ethanol, 2-propanol, 1-propanol, and butanol. For example, in a case where the particle (d) is a metal resin particle subjected to hydrophobic surface modification, ketone-based, ester-based, carbonate-based, alkane, aromatic solvents, and the like are preferable, and examples thereof include methyl ethyl ketone (MEK), dimethyl carbonate, methyl acetate, acetone, methylene chloride, and cyclohexanone. A plurality of these solvents may be mixed to be used without remarkably deteriorating the dispersibility.

The composition (antireflection layer forming composition) used in the step (1) may contain a component in addition to the lubricant (a), the curable compound (b), the photopolymerization initiator (c), the particle (d), and the solvent, and, for example, may contain a dispersing agent of the particle (d), a leveling agent, and an antifouling agent.

The method of coating the substrate with the composition is not particularly limited, and well-known methods can be used. Examples thereof include a dip coating method, an air knife coating method, a curtain coating method, a roller coating method, a wire bar coating method, a gravure coating method, and a die coating method.

The content of the particle (d) in the layer (A) in the step (1) is preferably 0.10 to 0.30 g/m², more preferably 0.14 to 0.24 g/m², and even more preferably 0.16 to 0.20 g/m². In a case where the coating amount is 0.10 g/m² or greater, a large number of protrusions of the moth eye structure can be formed, and thus the antireflection properties are more easily improved. In a case where the coating amount is 0.30 g/m² or less, aggregation in the liquid hardly occurs and a moth eye structure is easily formed in a satisfactory manner.

<Dispersing Agent of Particle (d)>

The dispersing agent of the particle (d) lowers the cohesive force between the particles such that the particle (d) is evenly arranged. The dispersing agent is not particularly limited, but an anionic compound such as sulfuric acid salt and phosphoric acid salt, a cationic compound such as aliphatic amine salt and quaternary ammonium salt, a nonionic compound, and a polymer compound are preferable, and a polymer compound is more preferable since the polymer compound has a high degree of freedom in selecting adsorptive groups and steric repulsive groups. As the dispersing agent, a commercially available product may be used. Examples thereof include DISPERBYK160, DISPERBYK161, DISPERBYK162, DISPERBYK63, DISPERBYK164, DISPERBYK166, DISPERBYK167, DISPERBYK171, DISPERBYK180, DISPERBYK182, DISPERBYK2000, DISPERBYK2001, DISPERBYK2164, Bykumen BYK-2009, BYK-P104, BYK-P104S, BYK-220S, Anti-Terra203, Anti-Terra204, and Anti-Terra205 (all are trade names) manufactured by BYK Japan KK.

According to the present invention, before the step (1), a functional layer may be provided on the substrate. In a case where a functional layer is provided on the substrate, a laminate of the functional layer and the substrate is called a “substrate”. In a case where a functional layer is provided on a surface on which the layer (A) of the substrate is to be provided, the layer (A) is provided on the functional layer in the step (1) and subsequent steps are performed. As the functional layer, a hard coat layer is preferable.

According to the present invention, the substrate is preferably a substrate having a hard coat layer (also referred to as a “substrate with a hard coat layer”), and the hard coat layer is preferably coated with the composition in the step (1).

<Layer (A)>

The layer (A) is a layer in which the thickness of a portion in which the particle (d) is not present is set as a thickness of 0.8 times or more of the average primary particle diameter of the particle (d) by volatilizing a solvent from an antireflection layer forming composition applied to the substrate and includes the lubricant (a), the curable compound (b), the photopolymerization initiator (c), and the particle (d).

The layer (A) is a layer to become an antireflection layer by the manufacturing method of the present invention.

The curable compound (b) included in the layer (A) is cured to become a resin. This resin is for forming a recessed part in an uneven shape of the antireflection layer.

The particle (d) included in the layer (A) projects from the surface of the film formed from the resin in the obtained antireflection film and forms a protrusion of an uneven shape.

According to the present invention, since the lubricant (a) also has a crosslinking group, the lubricant (a) is cured with each other or with the curable compound (b) to become a cured product and is present in a recessed part. However, as described above, it is preferable that the cured product is present in the coating film that covers the surface of the particle (d) for forming this protrusion.

A portion of the layer (A) is cured in the step (2), and thus components contained before curing and after curing are different, but according to the present invention, for convenience, the layer (A) is referred to as the layer (A) at any stage. The layer (A) is also called the layer (A) before and after the steps (3) and (4) in the same manner.

In the step (1), in the coated layer (A), it is preferable that a plurality of particles (d) are not present in a direction orthogonal to the surface of the substrate. Here, the expression “the plurality of particle (d) are not present in the direction orthogonal to the surface of the substrate” indicates that, in a case where 10 μm×10 μm of the in-plane of the substrate is observed with three visual fields with a scanning electron microscope (SEM), the proportion of the number of (independently present) particles (d) in which a plurality of the particles are not present in the direction orthogonal to the surface is 80% or greater and preferably 95% or greater.

In the step (1), the film thickness of the portion in which the particle (d) of the layer (A) is not present is 0.8 times or more of the average primary particle diameter of the particle (d), preferably 0.8 times to 2.0 times, more preferably 0.9 times to 1.5 times, and particularly preferably 1.0 times to 1.2 times. Accordingly, the particle (d) hardly aggregate, and thus preferable uneven shape can be easily obtained.

[Step (2)]

As illustrated in (2) of FIG. 1, the step (2) is a step of curing a portion of the curable compound (b) in the layer (A) 4 of the step (1) and obtaining the cured compound (bc).

In the step (2), the lubricant (a) may be cured or may not be cured.

The compound (bc) may include one obtained by curing the lubricant (a) and the curable compound (b).

In a case where a portion of the curable compound (b) in the step (2) is cured, it is possible to prevent the particle (d) from moving and suppress the aggregation of the particle (d).

The expression of “curing a portion of the curable compound (b)” represents not curing all of the curable compounds (b) but curing only a portion thereof. In a case where only a portion of the curable compound (b) is cured in the step (2), the uncured curable compound (b) permeates the substrate by heating in the step (3), a thickness of a portion in which the particle (d) of the layer (A) is not present is caused to be small, the particle (d) projects, and the satisfactory uneven shape (moth eye structure) may be formed.

It is preferable that the curable compound (b) is a photocurable compound and a portion of the curable compound (b) is cured by performing irradiation with light (preferably ultraviolet rays) in the step (2).

In a case where the substrate is coated with the composition excluding the particle (d) from the antireflection layer forming composition in a thickness of 2 μm and the composition is cured, the condition of curing a portion of the curable compound (b) in the step (2) is preferably a condition in which a curing rate becomes 2% to 20%, more preferably a condition in which a curing rate becomes 3% to 15%, and even more preferably a condition in which a curing rate becomes 5% to 10%.

The curing rate is

{(1−the number of residual polymerizable functional groups after curing/the number of polymerizable functional groups before curing}×100%

and is measured by the following method.

The polymerizable functional group is a group having a polymerizable carbon-carbon unsaturated double bond.

Specifically, NICOLET6700 FT-IR of Thermo electron corporation is used, KBr-IR of the curable compound before curing is measured, a peak (1,660-1,800 cm⁻¹) area of the carbonyl group and a peak height (808 cm⁻¹) of the polymerizable carbon-carbon unsaturated double bond are determined, a peak of the polymerizable carbon-carbon unsaturated double bond with respect to the carbonyl group peak area is obtained in the same manner as in the IR measurement of single reflection after curing, and peaks before and after ultraviolet ray irradiation are compared, so as to calculate the curing rate. Here, with respect to the calculation of the curing rate, the measured depth at 808 cm⁻¹ is regulated as 821 nm, and the depth at 1,660-1,800 cm⁻¹ is regulated as 384 nm.

In the step (2), the ultraviolet ray is preferably applied in the irradiation amount of 1 to 90 mJ/cm², more preferably applied in the irradiation amount of 1.2 to 40 mJ/cm², and even more preferably applied in the irradiation amount of 1.5 to 10 mJ/cm².

In the step (2), it is preferable that a portion of the curable compound (b) is cured by irradiation with the ultraviolet ray from the opposite side of the side having the layer (A) of the substrate. Accordingly, particularly, it is possible to cure the area of the layer (A) on the substrate side, and the protrusion due to the particle (d) is easily formed in the subsequent step, while the particle (d) is caused not to be moved.

In step (2), it is preferable that the process is performed in the environment of the oxygen concentration of 0.1 to 5.0 volume %, and it is more preferable that the process is performed in the environment of the oxygen concentration of 0.5 to 1.0 volume %. In a case where the oxygen concentration is caused to be in the above range, particularly, the area of the layer (A) on the substrate side can be cured.

The compound (bc) is a cured product of the curable compound (b).

The molecular weight of the compound (bc) is not particularly limited. The compound (bc) may have an unreacted polymerizable functional group.

[Step (3)]

As illustrated in (3) of FIG. 1, the step (3) is a step of causing a portion of a compound selected from the group consisting of the curable compound (b) and the compound (bc) in the layer (A) 4 to permeate the substrate by heating or performing volatilization so as to form an uneven shape including the particle (d) on a surface of the layer (A) opposite to the substrate. Here, the curable compound (b) that permeates the substrate by heating or is volatilized is preferably the curable compound (b) that is not cured in the step (2).

In the step (3), the lubricant (a) preferably does not permeate the substrate and preferably is not volatilized.

In the step (3) of causing a portion of the compound selected from the group consisting of the curable compound (b) and the compound (bc) to permeate the substrate (may be a functional layer in a case where the substrate has a functional layer), it is preferable to heat a laminate having the substrate and the layer (A). It is possible to effectively cause a portion of the compound selected from the group consisting of the curable compound (b) and the compound (bc) to permeate the substrate by heating. The temperature in heating is preferably smaller than the glass transition temperature of the substrate. Specifically, the temperature is preferably 60° C. to 150° C. and more preferably 80° C. to 120° C.

In a case where the step (3) is a step of volatilizing a portion of the compound selected from the group consisting of the curable compound (b) and the compound (bc), a boiling point of the curable compound (b) at 1 atm is preferably 150° C. or lower, and a molecular weight thereof is preferably 300 or less. Specifically, BLEMMER GMR is preferable.

1 atm is 101,325 Pa.

In the step (3), a portion of a compound selected from the group consisting of the curable compound (b) and the compound (bc) in the layer (A) permeates the substrate by heating or is volatilized so as to form an uneven shape on a surface of the layer (A). The protrusion of this uneven shape is the particle (d) and the recessed part is a compound selected from the group consisting of the lubricant (a), the curable compound (b), and the compound (bc), which remain in the layer (A).

[Step (4)]

As illustrated in (4) in FIG. 1, the step (4) is a step of curing the compound selected from the group consisting of the lubricant (a), the curable compound (b), and the compound (bc), which remain in the layer (A).

The curing in the step (4) is preferably photocuring, and is more preferably is curing by the ultraviolet ray irradiation. The irradiation amount of the ultraviolet ray is preferably 300 mJ/cm² or greater, and it is preferable that the curing is performed in the environment of the oxygen concentration of 0.01 volume % or less.

In the step (4), the compound that is selected from the group consisting of the lubricant (a), the curable compound (b), and the compound (bc) and that remains in the layer (A) is cured so as to obtain a resin, and an antireflection layer is formed having a moth eye structure formed of an uneven shape with this resin as a recessed part and the particle (d) projecting from the resin as protrusion.

After the step (4), the average surface roughness Ra is preferably 15 nm or greater, more preferably 30 nm or greater, and most preferably 40 nm or greater.

[Steps (E1) and (E2)]

The present invention preferably includes a step (E1) of providing a layer (E) including a compound (e) incompatible with the curable compound (b) on a surface opposite to a surface of the layer (A) on the substrate side between the step (1) and the step (2), between the step (2) and the step (3), or between the step (3) and the step (4) and

a step (E2) of removing the layer (E) after the step (2), (3), or (4) subsequent to the step (E1).

The step (E1) is preferably included between the steps (1) to (3) and more preferably included between the steps (2) and (3).

The step (E2) is preferably included after the step (4).

<Layer (E)>

The layer (E) includes the compound (e) (also simply referred to as the “compound (e)”) incompatible with the curable compound (b).

It is preferable that the layer (E) is provided such that the particle (d) in the layer (A) does not aggregate and it is preferable that the layer (E) is finally removed.

The expression “the compound (e) is required to be incompatible with the curable compound (b)” means that an insoluble matter remains in a case where the compound (e) is mixed and stirred at 25° C. by 5 mass % with respect to the curable compound (b).

The compound (e) is preferably a compound which is not cured by heat. It is preferable that the compound (e) is a compound which is not cured by heat, because even in a case where a heating process is included before the compound (e) is removed in the manufacturing method of the present invention, the moth eye structure can be easily formed with the particle (d).

Particularly, in a case where the layer (E) is provided before the step (3), the boiling point of the compound (e) of the layer (E) is preferably a heating temperature or higher in the step (3).

In the case where the layer (E) is provided as the compound (e) by coating, it is preferable that the compound (e) is an oil component which is a liquid at 50° C. and is more preferably a silicone-based oil component, a hydrocarbon-based oil component, an ester-based oil component, a natural animal and vegetable oils and fats, semisynthetic oils and fats, higher fatty acid, higher alcohols, or a fluorine-based oil component.

<<Silicone-Based Oil Component>>

The silicone-based oil component may be any one of a solid shape, a semisolid shape, and a liquid shape. As the silicone-based oil component, for example, silicone oil, a silicone-based oil surfactant, a silicone resin, a silicone wax, and a silicone-based gelling agent may be used.

Examples of the silicone oil include low viscosity to high viscosity linear or branched organopolysiloxane such as dimethyl polysiloxane (for example, KF96 series manufactured by Shin-Etsu Chemical Co., Ltd.), tristrimethylsiloxymethylsilane, capryllyl methicone, phenyl trimethicone, tetrakistrimethylsiloxysilane, methylphenyl polysiloxane, methylhexyl polysiloxane, methyl hydrogen polysiloxane, and a dimethylsiloxane-methylphenylsiloxane copolymer; cyclic organopolysiloxane such as octamethyl cyclotetrasiloxane, decamethyl cyclopentasiloxane, dodecamethyl cyclohexasiloxane, tetramethyl tetrahydrogen cyclotetrasiloxane, and tetramethyl tetraphenyl cyclotetrasiloxane; amino-modified organopolysiloxane: pyrrolidone-modified organopolysiloxane: pyrrolidone carboxylic acid-modified organopolysiloxane; silicone rubber such as a gum-like dimethylpolysiloxane having a high degree of polymerization, gum-like amino-modified organopolysiloxane, and a gum-like dimethylsiloxane-methylphenylsiloxane copolymer: silicone gum or a rubber cyclic organopolysiloxane solution: trimethylsiloxysilicic acid, a cyclic siloxane solution of trimethylsiloxysilicic acid (for example, KF-7312J manufactured by Shin-Etsu Chemical Co., Ltd.); higher alkoxy-modified silicone such as stearoxy silicone; higher fatty acid-modified silicone: alkyl-modified silicone; long chain alkyl-modified silicone; amino acid-modified silicone: fluorine-modified silicone; and a solution of a silicone resin.

Examples of the silicone-based surfactant include linear or branched polyoxyethylene-modified organopolysiloxane, linear or branched polyoxyethylene polyoxypropylene-modified organopolysiloxane, linear or branched polyoxyethylene-alkyl co-modified organopolysiloxane, linear or branched polyoxyethylene polyoxypropylene-alkyl co-modified organopolysiloxane, linear or branched polyglycerin-modified organopolysiloxane, and linear or branched polyglycerol-alkyl co-modified organopolysiloxane (as specific examples, silicone-based surfactants manufactured by Shin-Etsu Chemical Co., Ltd.: KF-6011, 6043, 6028, 6038, 6100, 6104, and 6105). The silicone-based surfactant may be used in a state of coexisting with other oil components such as polyoxyethylene-modified partially crosslinked organopolysiloxane, and polyglycerin-modified partially crosslinked organopolysiloxane (for example, manufactured by Shin-Etsu Chemical Co., Ltd., KSG series: KSG-210, 710, 310, 320, 330, 340, 320Z, 350Z, 810, 820, 830, 840, 820Z, and 850Z).

Examples of the silicone resin include an acrylic silicone resin consisting of an acryl/silicone graft copolymer, an acryl/silicone block copolymer, and the like (specific examples thereof include: a cyclic organopolysiloxane solution of an acryl/silicone graft copolymer: KP-545 manufactured by Shin-Etsu Chemical Co., Ltd.). An acrylic silicone resin containing at least one selected from a pyrrolidone portion, a long chain alkyl portion, a polyoxyalkylene portion, and a fluoroalkyl portion, and an anion portion such as carboxylic acid in a molecule can also be used. The silicone resin is preferably a network-shaped silicone compound including at least one kind of a resin including a R⁸₃SiO_{0.5} unit and a SiO₂ unit, a resin including a R⁸₃SiO_{0.5} unit, a R⁸₂SiO unit, and a SiO₂ unit, a resin including a R⁸₃SiO_{0.5} unit and a R⁸₃SiO_{0.5} unit, a resin including a R⁸₃SiO_{0.5} unit, a R⁸₂SiO unit, and a R⁸SiO_{1.5} unit, and a resin including a R⁸₃SiO_{0.5} unit, a R⁸₂SiO unit, a R⁸SiO_{1.5} unit, and a SiO₂ unit. R⁸ in the formula is a substituted or unsubstituted monovalent hydrocarbon group having 1 to 30 carbon atoms. A network-shaped silicone compound containing at least one selected from a pyrrolidone moiety, a long chain alkyl moiety, a polyoxyalkylene moiety, a polyglycerin moiety, a fluoroalkyl moiety, and an amino moiety in a molecule can also be used.

Examples of the silicone wax include an acrylic silicone wax consisting of an acryl/silicone graft copolymer, an acryl/silicone block copolymer, and the like (specific examples thereof include: a cyclic organopolysiloxane solution of an acryl/silicone graft copolymer: KP-561P and KP-562P manufactured by Shin-Etsu Chemical Co., Ltd.). An acrylic silicone wax containing at least one selected from a pyrrolidone portion, a long chain alkyl portion, a polyoxyalkylene portion, and a fluoroalkyl portion, and an anion portion such as carboxylic acid in a molecule can also be used. The silicone wax is preferably polylactone-modified polysiloxane bonding a polylactone which is a ring-opening polymer of a five or more-membered lactone compound. This silicone wax is a silicone-modified olefin wax obtained by performing addition reaction of an olefin wax having an unsaturated group consisting of α-olefin and diene with organohydrogenpolysiloxane having one or more SiH bonds in one molecule. The above α-olefin is preferably α-olefin having 2 to 12 carbon atoms such as ethylene, propylene, 1-butene, 1-hexene, and 4-methyl-1-pentene, and the above diene is preferably butadiene, isoprene, 1,4-hexadiene, vinyl norbomene, ethylidene norbornene, and dicyclopentadiene. As the organohydrogenpolysiloxane having SiH bonds, organohydrogenpolysiloxane having a linear structure, organohydrogenpolysiloxane having a siloxane branched structure, and the like can be used.

Examples of the silicone-based gelling agent include a gel mixture including a gelling component such as an unmodified or modified partially crosslinked organopolysiloxane such as unmodified partially crosslinked organopolysiloxane, alkyl-modified partially crosslinked organopolysiloxane, and silicone branched alkyl-modified partially crosslinked organopolysiloxane and various oil components such as cyclopentasiloxane, dimethicone, mineral oil, isododecane, trioctanoin, and squalane. In the gel mixture, the gelling component and the oil component are contained in a coexisting manner. Examples of the gel mixture include KSG series (trade name) manufactured by Shin-Etsu Chemical Co., Ltd., particularly, KSG-15, 16, 41, 42, 43, 44, 042Z, and 045Z (all are trade names).

<<Hydrocarbon-Based Oil Component>>

Examples of the hydrocarbon-based oil component include liquid paraffin, light liquid isoparaffin, heavy flow isoparaffin, vaseline, n-paraffin, isoparaffin, isododecane, isohexadecane, polyisobutylene, hydrogenated polyisobutylene, polybutene, ozokerite, ceresin, microcrystalline wax, paraffin wax, polyethylene wax, polyethylene-polypropylene wax, squalane, squalene, pristane, polyisoprene, and wax.

<<Ester-Based Oil Component>>

Examples of the ester-based oil component include hexyldecyl octanoate, cetyl octanoate, isopropyl myristate, isopropyl palmitate, butyl stearate, hexyl laurate, myristyl myristate, oleyl oleate, decyl oleate, octyldodecyl myristate, hexyldecyl dimethyloctanoate, cetyl lactate, myristyl lactate, diethyl phthalate, dibutyl phthalate, lanolin acetate, ethylene glycol monostearate, propylene glycol monostearate, propylene glycol dioleate, glyceryl monostearate, glyceryl monooleate, glyceryl tri-2-ethylhexanoate, trimethylolpropane tri-2-ethylhexanoate, ditrimethylolpropane triethylhexanoate, (isostearic acid/sebacic acid) ditrimethylolpropane, trimethylolpropane trioctanoate, trimethylolpropane triisostearate, diisopropyl adipate, diisobutyl adipate, 2-hexyldecyl adipate, di-2-heptylundecyl adipate, diisostearyl malate, monoisostearic acid hydrogenated castor oil, N-alkyl glycol monoisostearate, octyldodecyl isostearate, isopropyl isostearate, isocetyl isostearate, ethylene glycol di-2-ethylhexanoate, cetyl 2-ethylhexanoate, pentaerythritol tetra-2-ethylhexanoate, octyl dodecyl gum ester, ethyl oleate, octyldodecyl oleate, neopentyl glycol dicaprate, triethyl citrate, 2-ethylhexyl succinate, dioctyl succinate, isocetyl stearate, diisopropyl sebacate, di-2-ethylhexyl sebacate, diethyl sebacate, dioctyl sebacate, dibutyl octyl sebacate, cetyl palmitate, octyldodecyl palmitate, octyl palmitate, 2-ethylhexyl palmitate, 2-hexyldecyl palmitate, 2-heptylundecyl palmitate, cholesteryl 12-hydroxystearate, dipentaerythritol fatty acid ester, 2-hexyldecyl myristate, ethyl laurate, N-lauroyl-L-glutamic acid-2-octyldodecyl ester. N-lauroyl-L-glutamic acid di(cholesteryl/behenyl/octyldodecyl), N-lauroyl-L-glutamic acid di(cholestery/octyldodecyl). N-lauroyl-L-glutamic acid di(phytosteryl/behenyl/octyldodecyl), N-lauroyl-L-glutamic acid di(phytosteryl/octyldodecyl), N-lauroylsarcosine isopropyl, diisostearyl malate, neopentyl glycol dioctanoate, isodecyl neopentanoate, isotridecyl neopentanoate, isostearyl neopentanoate, isononyl isononanoate, isotridecyl isononanoate, octyl isononanoate, isotridecyl isononanoate, diene pentane diene pentane diol, dineopentanoic acid methyl pentanediol, octyldodecyl neodecanoate, 2-butyl-2-ethyl-1,3-propanediol dioctanoate, pentaerythrityl tetraoctanoate, hydrogenated rosin pentaerythrityl, pentaerythrityl triethylhexanoate, (hydroxystearic acid/stearic acid/rosin acid) dipentaerythrityl, polyglyceryl tetraisostearate, nona isostearic acid polyglyceryl-10, deca(erucic acid/isostearic acid/ricinoleic acid) polyglyceryl-8, (hexyldecanoic acid/sebacic acid) diglyceryl oligoester, glycol (ethylene glycol distearate) distearate, diisopropyl dimer dilinoleate, diisostearyl dimer dilinoleate, di(isostearyliphytosteryl) dimer dilinoleate, (phytosteryl/behenyl) dimer dilinoleate, (phytosteryl/isostearyl/cetyl/stearyl/behenyl) dimer dilinoleate, dimer dilinoleyl dimer dilinoleate, dimer dilinoleyl diisostearate, dimer dilinoleyl hydrogenated rosinate, hydrogenated castor oil dimer dilinoleate, hydroxyalkyl dimer dilinoleyl ether, glyceryl triisooctanoate, glyceryl triisostearate, glyceryl trimyristate, glyceryl triisopalmitate, glyceryl trioctanoate, glyceryl trioleate, glyceryl diisostearate, tri(caprylic/capric acid) glyceryl, tri(caprylic/capric/myristic/stearic) glyceryl, hydrogenated rosin triglyceride (hydrogenated ester gum), rosin triglyceride (ester gum), glyceryl behenate eicosane diacid, glyceryl di-2-heptylundecanoate, diglyceryl myristate isostearate, cholesteryl acetate, cholesteryl nonanoate, cholesteryl stearate, cholesteryl isostearate, cholesteryl oleate, cholesteryl 12-hydroxystearate, macadamia nut oil fatty acid cholesteryl, macadamia nut oil fatty acid phytosteryl, phytosteryl isostearate, soft lanolin fatty acid cholesteryl, hard lanolin fatty acid cholesteryl, long chain branched fatty acid cholesteryl, long chain a-hydroxy fatty acid cholesteryl, octyldodecyl ricinoleate, lanolin fatty acid octyldodecyl, octyldodecyl erucate, isostearic acid hydrogenated castor oil, avocado oil fatty acid ethyl, and lanolin fatty acid isopropyl.

<<Natural Animal and Vegetable Fats and Oils and Semisynthetic Fats and Oils>>

Examples of the natural animal and vegetable fats and oils and semisynthetic fats and oils include avocado oil, linseed oil, almond oil, ibotarou, eno oil, olive oil, cocoa butter, kapok row, kaya oil, camauba wax, liver oil, candelilla wax, beef tallow, beef leg fat, beef bone fat, hardened beef tallow, kyunin oil, spermaceti, hydrogenated oil, wheat germ oil, sesame oil, rice germ oil, rice bran oil, sugarcane wax, sasanqua oil, safflower oil, shea butter, synergist oil, cinnamon oil, jojo barrow, olive squalane, shellac wax, turtle oil, soybean oil, tea seed oil, camellia oil, evening primrose oil, corn oil, lard, rapeseed oil, Japanese tung oil, nukaro, germ oil, horse fat, persic oil, palm oil, palm kernel oil, castor oil, hydrogenated castor oil, castor oil fatty acid methyl ester, sunflower oil, grape oil, bayberry row, jojoba oil, hydrogenated jojoba ester, macadamia nut oil, beeswax, mink oil, cotton seed oil, cotton wax, Japan wax. Japan wax kernel oil, montan wax, coconut oil, hardened coconut oil, tri-coconut oil fatty acid glyceride, tamba, peanut oil, lanolin, liquid lanolin, reduced lanolin, lanolin alcohol, hard lanolin, lanolin acetate, lanolin fatty acid isopropyl, polyoxyethylene (POE) lanolin alcohol ether, POE lanolin alcohol acetate, lanolin fatty acid polyethylene glycol, POE hydrogenated lanolin alcohol ether, and egg yolk oil.

<<Higher Fatty Acid>>

Examples of the higher fatty acid include lauric acid, myristic acid, palmitic acid, stearic acid, behenic acid, undecylenic acid, oleic acid, linoleic acid, linolenic acid, arachidonic acid, eicosapentaenoic acid (EPA), docosahexaenoic acid (DHA), isostearic acid, and 12-hydroxystearic acid.

<<Higher Alcohol>>

Examples of the higher alcohol include lauryl alcohol, myristyl alcohol, palmityl alcohol, stearyl alcohol, behenyl alcohol, hexadecyl alcohol, oleyl alcohol, isostearyl alcohol, hexyl dodecanol, octyldodecanol, cetostearyl alcohol, 2-decyltetradecinol, cholesterol, sitosterol, phytosterol, lanosterol, POE cholesterol ether, monostearyl glycerin ether (batyl alcohol), and monooleyl glyceryl ether (selachyl alcohol).

<<Fluorine-Based Oil Component>>

Examples of the fluorine-based oil component include perfluoropolyether, perfluorodecalin, and perfluorooctane.

In view of suppressing the aggregation of particles forming a moth eye structure and reducing the muddiness of the antireflection film, the compound (e) is preferably a liquid at 50° C. and more preferably a liquid at 25° C. At least one of the compounds (e) preferably has a boiling point of 110° C. or higher. It is preferable that at least one of the compounds (e) has a boiling point of 110° C. or higher, since it is difficult to be volatilized at room temperature and the layer (E) is present until the curing of layer (A) is completed.

In view of the above, the kinematic viscosity at 25° C. of the compound (e) having a boiling point of 110° C. or higher is preferably 0.1 mm²/s to 100,000 mm²/s, more preferably 0.1 mm²/s to 10,000 mm² is, and most preferably 0.1 mm² is to 100 mm²/s.

The compound (e) may be used singly and two or more kinds thereof may be used in combination.

The content of the compound (e) in the layer (E) is preferably 50 to 100 mass %, more preferably 70 to 100 mass %, and even more preferably 90 to 100 mass % with respect to the total mass of the layer (E).

In the step (E2), the method for removing the layer (E) is not particularly limited, and a method of using a solvent that dissolves the compound (e) without dissolving the substrate and the cured layer (A), a method of volatilizing the compound (e) by performing heating at a temperature higher than the boiling point of the compound (e), and a method of dissolving the compound (e) with an alkaline solution, and the like are preferable.

The solvent that dissolves the compound (e) without dissolving the substrate and the cured layer (A) is not particularly limited. In a case where the substrate is triacetyl cellulose, an alcohol-based solvent such as methanol, ethanol, 2-propanol, 1-propanol, n-butanol, isobutanol, diacetone alcohol, and methoxypropanol, a ketone-based solvent such as methyl isobutyl ketone and methyl butyl ketone, an aromatic solvent such as toluene and xylene, cyclohexane, propylene glycol monomethyl ether acetate, and the like are preferable. The plurality of kinds of the solvents may be used together.

The heating temperature in a case where the compound (e) is volatilized is preferably a temperature lower than the glass transition temperature of the substrate and higher than the boiling point of the compound (e), and is specifically preferably 60° C. to 180° C. and more preferably 80° C. to 130° C.

As a solution in a case of being dissolved in an alkaline solution, an aqueous solution of sodium hydroxide or potassium hydroxide is preferably used.

<Other Layers>

As described above, other layers may be formed between the substrate and the layer (A). In this case, a laminate formed of the substrate and the other layers is called a substrate. Examples of the other layers include various functional layers, and a hard coat layer is particularly preferable.

(Hard Coat Layer)

The hard coat layer is preferably formed by the crosslinking reaction of the curable compound or the polymerization reaction. For example, the hard coat layer is preferably formed by coating the substrate with a hard coat layer forming composition including a polyfunctional monomer and/or a polyfunctional oligomer and subjecting the polyfunctional monomer or the polyfunctional oligomer to crosslinking reaction or polymerization reaction.

As the functional group (polymerizable group) of the polyfunctional monomer or the polyfunctional oligomer, those having light, electron beams, or radiation polymerizability are preferable. Among them, a photopolymerizable (preferably, ultraviolet ray polymerizable) functional group is preferable.

Examples of the photopolymerizable functional group include unsaturated polymerizable functional groups such as a (meth)acryloyl group, a vinyl group, a styryl group, and an allyl group. Among them, a (meth)acryloyl group is preferable.

With respect to the curable compound in the hard coat layer, disclosure in [0021] to [0027] of JP2014-240956A can be referred to the present invention.

In view of applying sufficient durability and impact resistance to the film, the film thickness of the hard coat layer is usually about 0.6 μm 50 μm and preferably 5 μm to 20 μm.

The hardness of the hard coat layer is preferably H or more and more preferably 2H or more in a pencil hardness test. Further, in the Taber test according to JIS K 5600-5-4 (1999), the more preferable, the smaller an abrasion amount of a test piece before and after the test is.

In a case where the hard coat layer is provided, for example, in a case where the pencil hardness test is performed, scratches on a plastic substrate (cellulose acylate substrate, acrylic substrate, or the like) can be further prevented.

In a case where the hard coat layer contains a curable compound, it is preferable that the curable compound of the hard coat layer is not cured in the step (2). Accordingly, a portion of the compound selected from the group consisting of the curable compound (b) and the compound (bc) in the layer (A) in the step (3) easily permeates the hard coat layer.

In order to cause the curable compound of the hard coat layer not to be cured in the step (2), the following aspect can be exemplified. In the following aspect, the curable compound included in the hard coat layer forming composition and the antireflection layer forming composition is a photocurable compound. In the step (3), a portion of the curable compound (b) of the layer (A) permeates the hard coat layer by heating.

The hard coat layer is formed by curing the hard coat layer forming composition containing the curable compound, and the increase amount of the curing rate due to curing in the step (2) is preferably less than 5%, more preferably less than 3%, and most preferably less than 1.5%.

In a case where the antireflection layer is provided on the substrate with a hard coat layer, Aspects 1 to 4 below are preferable.

Aspect 1: Aspect of containing a photoradical polymerization initiator A in the hard coat layer forming composition and containing the photoradical polymerization initiator A in the antireflection layer forming composition

In this aspect, the substrate is coated with the hard coat layer forming composition, irradiation with an ultraviolet ray is performed in a comparatively weak exposure amount, a portion of the photoradical polymerization initiator A is cleaved to generate radicals, and a portion thereof is not cleaved. At this point, a portion of the curable compound of the hard coat layer is cured. Thereafter, the hard coat layer is coated with the antireflection layer forming composition, and a portion of the curable compounds (b) is cured in the step (2). Thereafter, a portion of the uncured curable compounds (b) permeates the hard coat layer in the step (3), irradiation with the ultraviolet rays is performed in the step (4), and the curable compound of the hard coat layer and the uncured curable compounds (b) are cured.

Aspect 2: Aspect of containing a photoradical polymerization initiator A and the radical polymerization initiator that generates radicals by heat in the hard coat layer forming composition and containing the photoradical polymerization initiator A in the antireflection layer forming composition

In this aspect, the substrate is coated with the hard coat layer forming composition, an ultraviolet irradiation with ray is performed in a comparatively strong exposure amount, almost all of the photoradical polymerization initiator A is cleaved to generate radicals. At this point, a portion of the curable compound of the hard coat layer is cured. Thereafter, the hard coat layer is coated with the antireflection layer forming composition, and a portion of the curable compound (b) is cured in the step (2). Thereafter, a portion of the uncured curable compounds (b) permeates the hard coat layer in the step (3), irradiation with the ultraviolet rays is performed in the step (4), and the uncured curable compound (b) is cured. Thereafter, the thermal polymerization initiator in the hard coat layer is cleaved by heating so as to generate radicals, and the curable compound is cured. The temperature for generating radicals from the thermal radical polymerization initiator is preferably higher than the permeating temperature in the step (3) and is preferably, for example, 100° C. to 180° C. As the thermal radical polymerization initiator, VF-096 and VAm-11 (above, manufactured by Wako Pure Chemical Industries, Ltd), and the like can be suitably used.

Aspect 3: Aspect of containing the photoradical polymerization initiator A that generates radicals by irradiating the hard coat layer forming composition with ultraviolet rays by using a lamp A and containing the photoradical polymerization initiator A and a photoradical polymerization initiator B that generates radicals by being irradiated with ultraviolet rays by using a lamp B in the antireflection layer forming composition

In this aspect, the substrate is coated with the hard coat layer forming composition, irradiation with an ultraviolet ray is performed in a comparatively weak exposure amount by using a lamp A, a portion of the photoradical polymerization initiator A is consumed, and a portion thereof is remained. At this point, a portion of the curable compound of the hard coat layer is cured. After the hard coat layer is coated with the antireflection layer forming composition, a portion of the curable compound (b) is cured by being irradiated with ultraviolet rays by using a lamp B in the step (2). Thereafter, a portion of the uncured curable compounds (b) permeates the hard coat layer in the step (3), and the uncured curable compound (b) and the curable compound of the hard coat layer are cured by being irradiated with ultraviolet rays by using a lamp A in the step (4). Examples of the combination of the lamp A and the photoradical polymerization initiator A include a high-pressure mercury lamp having a strong specific wavelength spectrum and IRGACURE 907 and IRGACURE 369. Examples of the combination of the lamp B and the photoradical polymerization initiator B include a metal halide lamp having a relatively broad wavelength spectrum and IRGACURE 127 and IRGACURE 184. It is preferable to shift the cleaving wavelength of the initiator by using UV-LED light having a relatively long wavelength.

Aspect 4: Aspect containing a thermal radical polymerization initiator that generates a radical by heat in a hard coat layer forming composition and containing the photoradical polymerization initiator A in an antireflection layer forming composition

According to this aspect, the substrate is coated with the hard coat layer forming composition, a portion of the thermal radical polymerization initiator is consumed by slightly applying heat, and a portion thereof remains. At this point, a portion of the curable compound of the hard coat layer is cured. Thereafter, the hard coat layer is coated with the antireflection layer forming composition, and a portion of the curable compound (b) is cured by performing irradiation with ultraviolet rays in the step (2). Thereafter, a portion of the uncured curable compounds (b) permeates the hard coat layer in the step (3), irradiation with the ultraviolet rays is performed in the step (4), and the uncured curable compounds (b) are cured. Thereafter, heating is performed, a radical is generated by a thermal radical polymerization initiator in a hard coat layer, and a curable compound is cured. The temperature for generating radicals from the thermal radical polymerization initiator is preferably higher than the permeating temperature in the step (3) and is preferably, for example, 100° C. to 180° C.

The antireflection film manufactured by the manufacturing method of the present invention may be suitably used as a polarizing plate protective film.

The polarizing plate protective film using the antireflection film manufactured by the manufacturing method of the present invention may be bonded to a polarizer to form a polarizing plate and may be suitably used in a liquid crystal display device or the like.

### Examples

Hereinafter, the present invention is specifically described with reference to the examples. A material, a reagent, a substance quantity, a ratio thereof, an operation, and the like provided in the following examples can be suitably changed without departing from the gist of the present invention. Accordingly, the scope of the present invention is not limited to the following specific examples.

(Preparation of Substrate 1)

(Acetyl Substitution Degree)

An acetyl substitution degree of cellulose acylate is measured in the following method.

The acetyl substitution degree is measured in conformity with ASTM D-817-91.

(Preparation of Air Layer Cellulose Acylate Solution)

The following composition was put into a mixing tank and stirred while heating, and respective components were dissolved, so as to prepare an air layer cellulose acylate solution.

Composition of Air Layer Cellulose Acylate Solution

| | | |
|---|---|---|
| Cellulose acylate (Acetyl substitution degree | 100 | parts by mass |
| 2.86) | | |
| Sugar ester compound of Formula (I) | 3 | parts by mass |
| Sugar ester compound of Formula (II) | 1 | part by mass |
| Silica particle dispersion (average particle | 0.026 | parts by mass |
| diameter 16 nm) “AEROSIL R972”, | | |
| manufactured by Nippon Aerosil Co., Ltd. | | |
| Methylene chloride | 377 | parts by mass |
| Methanol | 61 | parts by mass |
| Butanol | 2.6 | parts by mass |

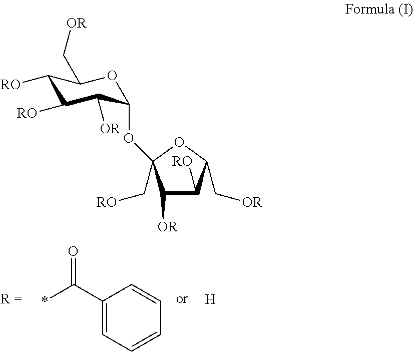

Average substitution degree of R=5.5

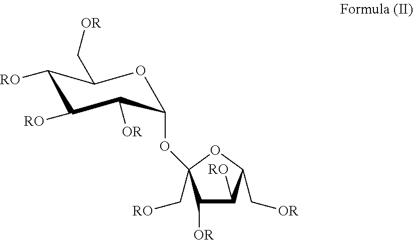

R=Acetyl group/i-butyryl group (2/6)

(Preparation of Drum Layer Cellulose Acylate Solution)

The following composition was put into a mixing tank and stirred while heating, and respective components were dissolved, so as to prepare a drum layer cellulose acylate solution.

Composition of Drum Layer Cellulose Acylate Solution

| | | |
|---|---|---|
| Cellulose acylate (Acetyl substitution degree | 100 | parts by mass |
| 2.86) | | |
| Sugar ester compound of Formula (I) | 3 | parts by mass |
| Sugar ester compound of Formula (II) | 1 | part by mass |
| Silica particle dispersion (average particle | 0.091 | parts by mass |
| diameter 16 nm) “AEROSIL R972”, | | |
| manufactured by Nippon Aerosil Co., Ltd. | | |
| Methylene chloride | 339 | parts by mass |
| Methanol | 74 | parts by mass |
| Butanol | 3 | parts by mass |

(Preparation of Core Layer Cellulose Acylate Solution)

The following composition was put into a mixing tank and stirred while heating, and respective components were dissolved, so as to prepare a core layer cellulose acylate solution.

Composition of Core Layer Cellulose Acylate Solution

| | |
|---|---|
| Cellulose acylate (Acetyl substitution degree 2.86) | 100 parts by mass |
| Sugar ester compound of Formula (I) | 8.3 parts by mass |
| Sugar ester compound of Formula (II) | 2.8 parts by mass |
| Methylene chloride | 266 parts by mass |
| Methanol | 58 parts by mass |
| Butanol | 2.6 parts by mass |

(Film Formation by Co-Casting)

A device set to be capable of forming a film having a three layer structure was used by mounting a feed block adjusted for co-casting as a casting die. The air layer cellulose acylate solution, the core layer cellulose acylate solution, and the drum layer cellulose acylate solution were cooled to −7° C. and co-cast from a casting port to a drum. At this point, the flow rate of each dope was adjusted such that that the thickness ratio became air layer/core layer/drum layer=7/90/3.

Each dope was cast on a mirror surface stainless steel support which was a drum having a diameter of 3 m. Dry air at 34° C. was applied to the drum at 300 m³/min.

Then, the cast and rotated cellulose acylate film was peeled off from the drum at 50 cm from the end point of the casting portion, and both ends were pinched with a pin tenter. In a case of peeling, stretching of 8% was performed in the transportation direction (longitudinal direction).

A cellulose acylate web held by a pin tenter was transported to a drying zone. Dry air at 45° C. was blown in the first drying and then drying was performed at 110° C. for 5 minutes. At this point, the cellulose acylate web was transported while stretching in the transverse direction at a magnification of 10%.

After the web was detached from the pin tenter, the portion held by the pin tenter was cut continuously, and unevenness at a height of 10 μm was provided at both ends of the web in the width direction with a width of 15 mm. The width of the web at this point was 1,610 mm. Drying was performed at 140° C. for 10 minutes while a tension of 130 N was applied in the transportation direction. Further, end portions in the width direction were continuously cut such that the web had a desired width, so as to prepare the substrate 1 having a film thickness of 60 μm. At this point, the film thicknesses of the end portions in the width direction cut off after drying at 140° C. and the central portion of the web were the same.

FUJITAC TG60UL is a cellulose acylate film manufactured by Fujifilm Corporation.

(Preparation of Substrate with Hard Coat Layer)

<Forming Hard Coat Layer A, Hard Coat Layer B, and Hard Coat Layer C>

FUJITAC TG60UL was coated with a coating liquid for forming hard coat layer A or B, the coating liquid was adjusted by nitrogen purge such that the oxygen concentration became 1.0 volume %, and the coating liquid was cured by being irradiated with an ultraviolet ray of 20 mJ/cm² by an air cooling metal halide lamp, so as to form a hard coat layer A or B having a film thickness of 8 μm.

A substrate with a hard coat layer used in Sample 102 was obtained by coating the substrate 1 with the coating liquid for forming the hard coat layer C of the composition, curing the coating liquid by irradiating the coating liquid with an ultraviolet ray of 1,000 mJ/cm² by an air cooling metal halide lamp while the coating liquid was adjusted by nitrogen purge such that the oxygen concentration became 1.0 volume %, and forming the hard coat layer C having a film thickness of 8 μm.

(Composition of Coating Liquid for Forming Hard Coat Layer A)

| | |
|---|---|
| UNIDIC 17-806 | 55.8 parts by mass |
| IRGACURE 127 | 1.9 parts by mass |
| Methyl ethyl ketone | 24.5 parts by mass |
| Methyl isobutyl ketone | 8.9 parts by mass |
| Methyl acetate | 8.9 parts by mass |

(Composition of Coating Liquid for Forming Hard Coat Layer B)

| | |
|---|---|
| UNIDIC 17-806 | 55.8 parts by mass |
| IRGACURE 127 | 1.9 parts by mass |
| Methyl ethyl ketone | 24.5 parts by mass |
| Methyl acetate | 17.8 parts by mass |

(Composition of Coating Liquid for Forming Hard Coat Layer C)

| | |
|---|---|
| PET-30 | 33.4 parts by mass |
| VF-096 | 1.4 parts by mass |
| IRGACURE 127 | 0.2 parts by mass |
| Methyl ethyl ketone | 35.8 parts by mass |
| Methyl acetate | 29.3 parts by mass |

UNIDIC17-806: Urethane acrylate (manufactured by DIC Corporation, Solution having a solid content of 80%)

PET-30: Mixture of 60% pentaerythritol triacrylate and 40% pentaerythritol tetraacrylate (KAYARAD PET-30 (manufactured by Nippon Kayaku Co., Ltd.))

IRGACURE 127: Photopolymerization initiator (manufactured by BASF Japan Ltd.)

VF-096: 2,2′-azobis[N-(2-propenyl)-2-methylpropionamide]: Thermal polymerization initiator

(Preparation of Coating Liquid for Forming Antireflection Layer Aa1)

Each component was introduced to a mixing tank so as to have the composition of the antireflection layer Aa1, was stirred for 60 minutes, was dispersed by an ultrasonic disperser for 30 minutes, and was filtrated with a polypropylene filter having a pore diameter of 5 μm to obtain a coating liquid for forming an antireflection layer.

(Composition of Coating Liquid for Forming Antireflection Layer Aa1)

| | |
|---|---|
| SIRIUS-501 | 2.5 parts by mass |
| Compound B | 3.9 parts by mass |
| KBM-4803 | 4.5 parts by mass |
| Ethanol | 15.3 parts by mass |
| Methyl ethyl ketone | 32.2 parts by mass |
| Acetone | 15.3 parts by mass |
| IRGACURE 127 | 0.4 parts by mass |
| Silica particle dispersion α | 25.9 parts by mass |
| Compound D | 0.08 parts by mass |

The compound D in the coating liquid for forming an antireflection layer Ab1 was a fluorine-containing polymer and the lubricant (a), SIRIUS-501, the compound B, and KBM-4803 were the curable compound (b), IRGACURE 127 was the photopolymerization initiator (c), the silica particle in the silica particle dispersion α was the particle (d), and ethanol, methyl ethyl ketone, and acetone were solvents.

Coating liquids for forming antireflection layers Aa2, Aa4, and Aa5 were prepared by using the lubricant (a) and the curable compound (b) described in Table 1 instead of the fluorine-containing polymer compound D and the curable compound (b) as the lubricant (a), in the same manner as the preparation of the coating liquid for forming the antireflection layer Aa1. The coating liquid for forming the antireflection layer Aa3 was prepared in the same manner as Aa4 except for using U-15HA instead of SIRIUS-501 and KBM-4803 as the curable compound (b).

(Preparation of Coating Liquid for Forming Antireflection Layer Ab1)

Each component was introduced to a mixing tank so as to have the composition of the antireflection layer Ab1, was stirred for 60 minutes, was dispersed by an ultrasonic disperser for 30 minutes, and was filtrated with a polypropylene filter having a pore diameter of 5 μm to obtain a coating liquid for forming an antireflection layer.

(Composition of Coating Liquid for Forming Antireflection Layer Ab1)

| | |
|---|---|
| SIRIUS-501 | 2.5 parts by mass |
| Compound B | 3.9 parts by mass |
| KBM-4803 | 4.5 parts by mass |
| Ethanol | 15.3 parts by mass |
| Methyl ethyl ketone | 32.2 parts by mass |
| Acetone | 15.3 parts by mass |
| IRGACURE 127 | 0.4 parts by mass |
| Silica particle dispersion α | 25.9 parts by mass |
| P-10 | 0.08 parts by mass |

Coating liquids for forming antireflection layers Ab2 to Ab8 were prepared by using the lubricant (a) and the curable compound (b) described in Table 1 instead of the silicone-based polymer P-10 and the curable compound (b) as the lubricant (a), in the same manner as the preparation of the coating liquid for forming the antireflection layer Ab1.

(Preparation of Coating Liquid for Forming Antireflection Layer Ac1)

Each component was introduced to a mixing tank so as to have the composition of the antireflection layer Ac1, was stirred for 60 minutes, was dispersed by an ultrasonic disperser for 30 minutes, and was filtrated with a polypropylene filter having a pore diameter of 5 μm to obtain a coating liquid for forming an antireflection layer.

(Composition of Coating Liquid for Forming Antireflection Layer Ac1)

| | |
|---|---|
| SIRIUS-501 | 2.5 parts by mass |
| Compound B | 3.9 parts by mass |
| KBM-4803 | 4.5 parts by mass |
| Ethanol | 15.3 parts by mass |
| Methyl ethyl ketone | 32.2 parts by mass |
| Acetone | 15.3 parts by mass |
| IRGACURE 127 | 0.4 parts by mass |
| Silica particle dispersion α | 25.9 parts by mass |
| Compound S-1 | 0.12 parts by mass |

Coating liquids for forming antireflection layers Ac2 to Ac20 were prepared by using the lubricant (a) and the curable compound (b) described in Table 1 instead of the silicone-based monomer compound S-1 and the curable compound (b) as the lubricant (a), in the same manner as the preparation of the coating liquid for forming the antireflection layer Ac1.

Compound B: Acryl group-containing trimethoxysilane represented by Formula (10) (manufactured by Shin-Etsu Chemical Co., Ltd.)

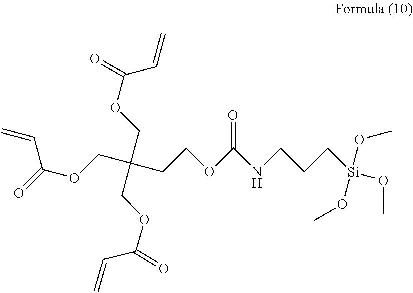 [SMILES: C=CC(=O)OCC(CCOC(=O)NCCC[Si](OC)(OC)OC)(COC(=O)C=C)COC(=O)C=C]

Compound C: A methyl ethyl ketone (MEK) solution of a fluorine-containing polymer SP-13 (weight-average molecular weight: 19,000) of the following structure having a concentration of a solid content of 40 mass %

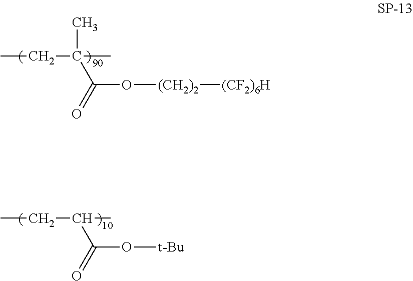

Compound D: A MEK solution of a fluorine-containing polymer (weight-average molecular weight: 11,000) of a structure represented by Formula (12) having a concentration of a solid content of 40 mass %

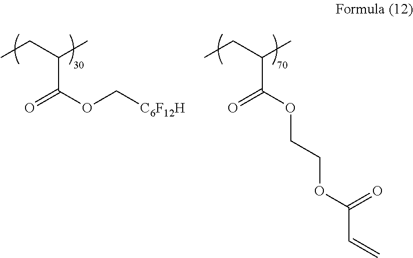

Compound E: A MEK solution of a fluorine-containing polymer (weight-average molecular weight: 17,000) of a structure represented by Formula (13) having a concentration of a solid content of 40 mass %

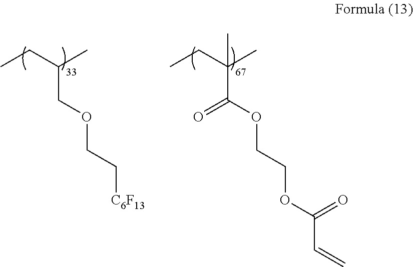

Compound F: A MEK solution of a fluorine-containing polymer (weight-average molecular weight: 11,000) of a structure represented by Formula (14) having a concentration of a solid content of 40 mass %

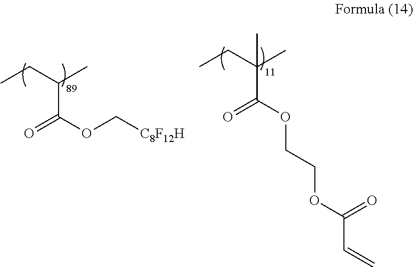

<Synthesis of Silicone-Based Polymer (P-10)>

A 1-methoxy-2-propanol solution (300 g) having a monomer in which a polydimethylsiloxane terminal was modified with methacryloxypropyl group (MCR-M11, manufactured by Gelest, Inc.) (0.2 mol), allyl methacrylate (0.8 mol), and 2,2′-azobis(2-methylbutyronitrile) (manufactured by Wako Pure Chemical Industries, Ltd.) (0.05 mol) was added dropwise to 1-methoxy-2-propanol (300 g) at 80° C. over four hours under a nitrogen stream. After completion of the dropwise addition, the mixture was further stirred at 85° C. for three hours so as to obtain Polymer (P-10). The polymer (P-10) was measured by a gel permeation chromatography method, and a weight-average molecular weight was 19,000. The structure of obtained Polymer (P-10) was identified by nuclear magnetic resonance (NMR).

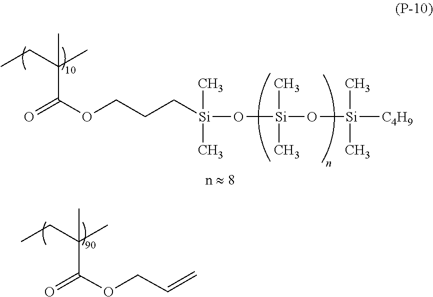

A silicone-based polymer (P-11) having the following structure was synthesized in the same manner as described above.

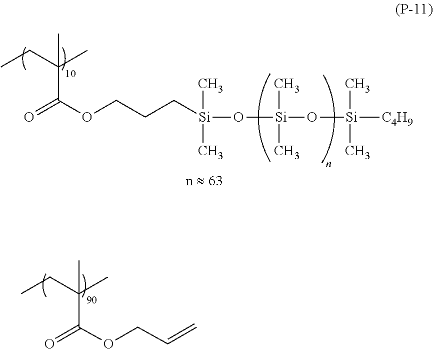

<Synthesis of Silicone-Based Polymer (P-12)>

A 1-methoxy-2-propanol solution (300 g) having a monomer in which a polydimethylsiloxane terminal was modified with a methacryloxypropyl group (MCR-M11, manufactured by Gelest, Inc.) (0.1 mol), a compound (M-1) having the following structure (0.9 mol), and 2,2′-azobis(2-methylbutyronitrile) (manufactured by Wako Pure Chemical Industries, Ltd.) (0.05 mol) was added dropwise to 1-methoxy-2-propanol (300 g) at 80° C. over four hours under a nitrogen stream. After completion of the dropwise addition, the mixture was further stirred at 85° C. for three hours so as to obtain a 1-methoxy-2-propanol solution of a precursor (Q-12) of the polymer (P-12).

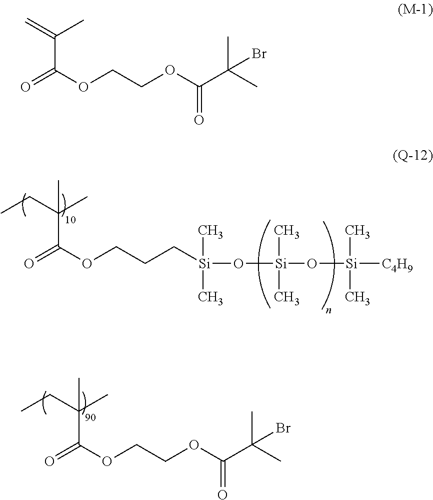

The obtained 1-methoxy-2-propanol solution of the precursor (Q-12) was cooled to 0° C., 4,4-dimethylaminopyridine (0.8 mol) was added dropwise over one hour, and gradually heated to room temperature (25° C.), and reacted at room temperature for two hours, so as to obtain a silicone-based polymer (P-12). The polymer (P-12) was measured by a gel permeation chromatography method, and a weight-average molecular weight was 14,000. The structure of the obtained polymer (P-12) was identified by NMR. In the following formula, n≈8.

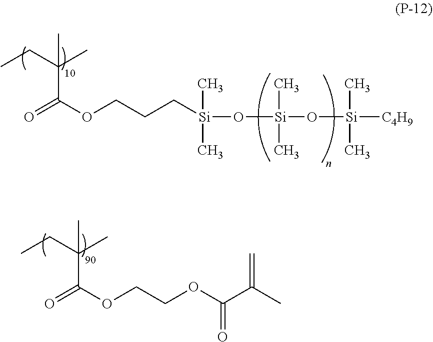

Silicone-based polymers (P-13) and (P-14) were synthesized in the same manner as described above.

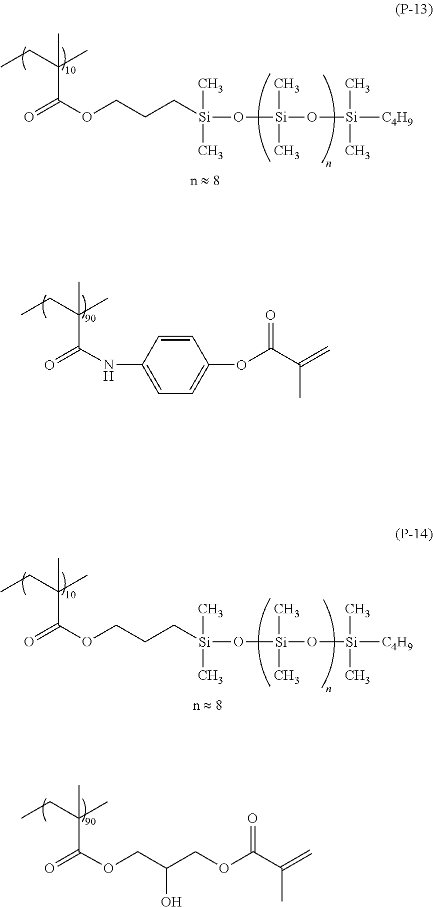

<Compounds (S-1) to (S-8)>

Compounds (S-1) to (S-8) were compounds described as specific examples of Formula (4) to (7).

<Silicone-Based Monomer (S-9)>

A silicone-based monomer (S-9) was a compound in which n was 10, and R⁴¹ was —CONH(CH₂)₃—, and R⁴² was —CH₃ in Formula (4).

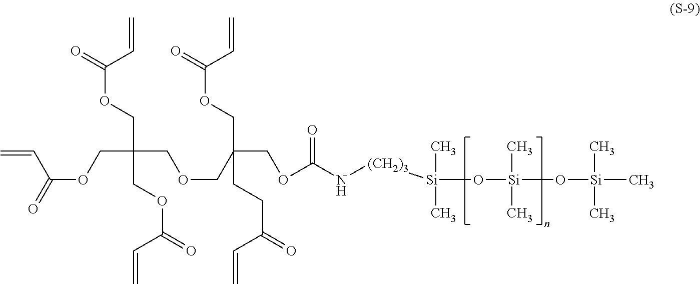

<Silicone-Based Monomer (S-10)>

A silicone-based monomer (S-10) as a compound in which n was 10, and R⁵¹ was —CONH(CH₂)₃—, and R⁵² was —CH₃ in Formula (5).

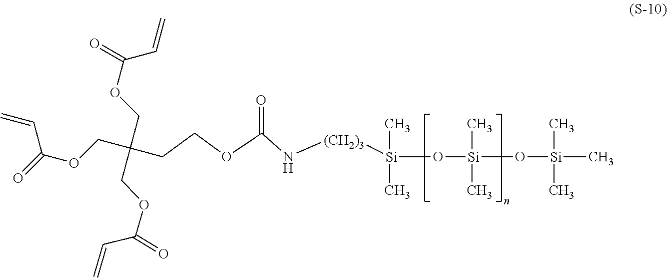

<Silicone-Based Monomer (S-11)>

A silicone-based monomer (S-11) was a compound in which n was 10, and R⁶¹ and R⁶² were —CONH(CH₂)₃— in Formula (6).

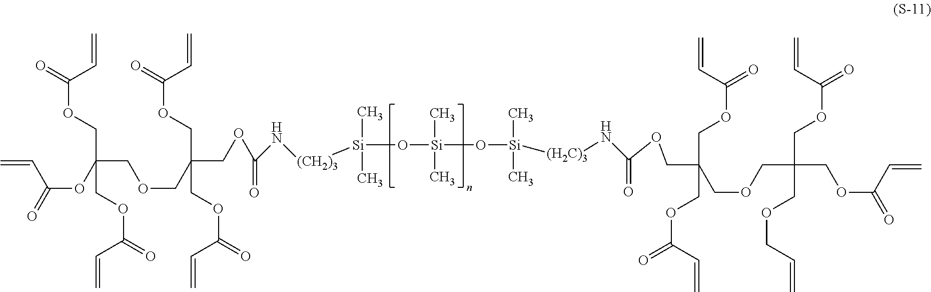

<Silicone-Based Monomer (S-12)>

A silicone-based monomer (S-12) was a compound in which n was 10, and R⁷¹ and R⁷² were —CONH(CH₂)₃— in Formula (7).

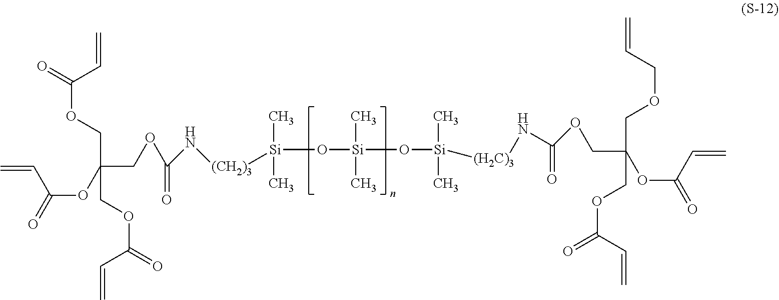

<Silicone-Based Monomer>

Compound (S-13): Compound in which n was 4, R⁴¹ was —(CH₂)₃—, and R⁴² was —CH₃ in Formula (4).

Compound (S-14): Compound in which n was 160, R⁴¹ was —(CH₂)₃—, and R⁴² was —CH₃ in Formula (4).

Compound (S-15): Compound in which n was 2, and R⁶¹ and R⁶² were —(CH₂)₃— in Formula (6).

Compound (S-16): Compound in which n was 102, and R⁶¹ and R⁶² were —(CH₂)₃— in Formula (6).

Silica particle dispersions α, β, and γ were respectively prepared in the following method.

(Preparation of Silica Particle Dispersion α)

KE-P20 was calcined at 1,050° C. for one hour in an electric furnace, was cooled, and was pulverized using a pulverizer. 5 kg of the calcined KE-P20 was introduced to a Henschel mixer (FM20J model manufactured by Nippon Coke & Engineering Co., Ltd.) having a capacity of 20 L equipped with a heating jacket. A solution obtained by dissolving 45 g of 3-acryloxypropyltrimethoxysilane (KBM 5103 manufactured by Shin-Etsu Chemical Co., Ltd.) in 90 g of methyl alcohol was added dropwise to a portion in which the calcined KE-P20 was stirred and mixed. Thereafter, in the heating treatment in which the resultant was heated to 150° C. over about one hour while mixing and stirring and was maintained at 150° C. for 12 hours, and the heating treatment was performed, the deposits on the wall were scraped off while the scraping device was rotated constantly in the opposite direction to the stirring blade. If necessary, the deposits on the wall were scraped off with a spatula. After heating, cooling was performed, and disintegration and classification were performed by using a jet pulverization classifier, so as to obtain a surface-treated particle with a silane coupling agent. An acryloyl group was provided to the surface of this particle.

80 parts by mass of MEK and 20 parts by mass of the silica particle were introduced to a mixing tank, were stirred for 10 minutes, and were subjected to ultrasonic dispersion for 30 minutes while stirring was continued, so as to prepare the silica particle dispersion α having 20 mass % of concentration of solid contents.

The average primary particle diameter of the silica particle included in the silica particle dispersion α was 180 nm.

(Preparation of Silica Particle Dispersion β)

KE-P30 was calcined at 1,050° C. for one hour in an electric furnace, was cooled, and was pulverized using a pulverizer. 5 kg of the calcined KE-P30 was introduced to a Henschel mixer (FM20J model manufactured by Nippon Coke & Engineering Co., Ltd.) having a capacity of 20 L equipped with a heating jacket. A solution obtained by dissolving 30 g of 3-acryloxypropyltrimethoxysilane (KBM 5103 manufactured by Shin-Etsu Chemical Co., Ltd.) in 90 g of methyl alcohol was added dropwise to a portion in which the calcined KE-P30 was stirred and mixed. Thereafter, in the heating treatment in which the resultant was heated to 150° C. over about one hour while mixing and stirring and was maintained at 150° C. for 12 hours, and the heating treatment was performed, the deposits on the wall were scraped off while the scraping device was rotated constantly in the opposite direction to the stirring blade. If necessary, the deposits on the wall were scraped off with a spatula. After heating, cooling was performed, and disintegration and classification were performed by using a jet pulverization classifier, so as to obtain a surface-treated particle with a silane coupling agent. An acryloyl group was provided to the surface of this particle.

80 parts by mass of MEK and 20 parts by mass of the silica particle were introduced to a mixing tank, were stirred for 10 minutes, and were subjected to ultrasonic dispersion for 30 minutes while stirring was continued, so as to prepare the silica particle dispersion β having 20 mass % of concentration of solid contents.

The average primary particle diameter of the silica particle included in the silica particle dispersion 01 was 270 nm.

(Preparation of Silica Particle Dispersion γ)

PL-7 (manufactured by Fuso Chemical Co., Ltd.) was calcined at 1,050° C. for one hour in an electric furnace, was cooled, and was pulverized using a pulverizer. 5 kg of the calcined PL-7 was introduced to a Henschel mixer (FM20J model manufactured by Nippon Coke & Engineering Co., Ltd.) having a capacity of 20 L equipped with a heating jacket. A solution obtained by dissolving 65 g of 3-acryloxypropyltrimethoxysilane (KBM 5103 manufactured by Shin-Etsu Chemical Co., Ltd.) in 90 g of methyl alcohol was added dropwise to a portion in which the calcined PL-7 was stirred and mixed. Thereafter, in the heating treatment in which the resultant was heated to 150° C. over about one hour while mixing and stirring and was maintained at 150° C. for 12 hours, and the heating treatment was performed, the deposits on the wall were scraped off while the scraping device was rotated constantly in the opposite direction to the stirring blade. If necessary, the deposits on the wall were scraped off with a spatula. After heating, cooling was performed, and disintegration and classification were performed by using a jet pulverization classifier, so as to obtain a surface-treated particle with a silane coupling agent. An acryloyl group was provided to the surface of this particle.

80 parts by mass of MEK and 20 parts by mass of the silica particle were introduced to a mixing tank, were stirred for 10 minutes, and were subjected to ultrasonic dispersion for 30 minutes while stirring was continued, so as to prepare the silica particle dispersion γ having 20 mass % of concentration of solid contents.

The average primary particle diameter of the silica particle included in the silica particle dispersion γ was 90 nm.

U-15HA: Urethane acrylate (acryl equivalent: 139, manufactured by Shin-Nakamura Chemical Co., Ltd.)

X-12-1048: Acrylic group-containing trimethoxysilane (acryl equivalent: 370, manufactured by Shin-Etsu Chemical Co., Ltd.)

SIRIUS-501: Dendrimer-type polyfunctional acrylate (acryl equivalent: 110, manufactured by Osaka Organic Chemical Industry Ltd.)

KBM-4803: Glycidoxy octyltrimethoxysilane (epoxy equivalent: 306, manufactured by Shin-Etsu Chemical Co., Ltd.)

KE-P20: SEAHOSTAR KE-P20 (average primary particle diameter: 200 nm, amorphous silica manufactured by Nippon Shokubai Co., Ltd.)

KE-P30: SEAHOSTAR KE-P30 (average primary particle diameter: 300 nm, amorphous silica manufactured by Nippon Shokubai Co., Ltd.)

PL-7: QUARTRON PL-7 Ultra high purity colloidal silica (average primary particle diameter: 100 nm, manufactured by Fuso Chemical Industry Co., Ltd.)

8SS-723: ACRIT 8SS-723 (crosslinking group equivalent: 338, manufactured by Taisei Fine Chemical Co., Ltd.)

8SS-1024: ACRIT 8SS-1024 (crosslinking group equivalent: 263, manufactured by Taisei Fine Chemical Co., Ltd.)

UMS-182: Polymerizable group-containing polydimethylsiloxane (molecular weight: 6,500, acryl equivalent: 545, manufactured by Gelest Inc.)

X-22-164C: Both terminals-type methacryloyl group-containing polydimethylsiloxane monomer (molecular weight: 4,800, acryl equivalent: 2,400, manufactured by Shin-Etsu Chemical Co., Ltd.)

X-22-164: Both terminals-type methacryloyl group-containing polydimethylsiloxane monomer (molecular weight: 380, acryl equivalent: 190, manufactured by Shin-Etsu Chemical Co., Ltd.)

Antireflection film samples 1 to 23 and 101 to 111 were prepared in the steps (1) to (4).

[Step (1) Application of Coating Liquid for Forming Antireflection Layer]

A hard coat layer of a substrate with a hard coat layer was coated with an antireflection layer forming coating liquid by using a die coater at 2.8 ml/m², and was dried for 90 seconds at room temperature.

A portion of the sample was cut out, irradiated with 600 mJ/cm² by an air cooling metal halide lamp and cured, and cut with a microtome to obtain a cross section, and SEM observation was performed at 5000 times, so as to measure the thickness of the resin with respect to the particle. In all examples and comparative examples, the thickness of the resin in a portion in which particles are not present was a thickness of 0.8 times or more of the average primary particle diameter of the particles.

[Step (2)]

Irradiation was performed at 2.0 mJ/cm² from the antireflection layer side in the step (2) by using an air cooling metal halide lamp in the environment of the oxygen concentration of 1.0%, so as to manufacture a sample having a curing rate of 6%. M04-L41 manufactured by Eye Graphics Co., Ltd. was used as the air cooling metal halide lamp.

With respect to the measurement of the irradiation amount, HEAD SENSER PD-365 was mounted on an eye ultraviolet ray integrating accumulation light meter UV METER UVPF-A1 manufactured by Eye Graphics, Inc., and the measurement was performed in a measurement range of 0.0.

In the sample 102, light irradiation was performed from the opposite side to the interface on the antireflection layer side of the substrate.

(Oil Coating)

Antireflection layers were coated with oil liquids in the following compositions (all are silicone oil manufactured by Shin-Etsu Chemical Co., Ltd.) to a thickness of 600 nm by using a die coater.

Composition of oil liquid

| | |
|---|---|
| KF96-10cs | 30.0 parts by mass |
| KF96-0.65cs | 70.0 parts by mass |

[Step (3)]

The laminate having the substrate, the hard coat layer, and the antireflection layer after the step (2) was treated at 120° C. for five minutes, to cause a portion of the curable compound to permeate into the substrate.

[Step (4)]

While nitrogen purge was performed so as to be an atmosphere in which the oxygen concentration became less than 0.01 volume %, irradiation with an ultraviolet ray of 600 mJ/cm² was performed by using the air cooling metal halide lamp described above, and the curable compound of the antireflection layer was cured to obtain a resin.

A portion of the sample was cut out, a cross section was obtained by performing cutting with a microtome, and SEM observation was performed at 5,000 times, so as to measure the thickness of the resin (a portion in which a particle is not present) with respect to the particle. Comparison was performed with the SEM observe image after the step (1), those in which the thickness of the resin was reduced by 0.4 times or more of the average primary particle diameter of the particles were determined that a portion of the curable compound permeated in the step (3).

(Oil Removal)

The example in which oil coating was performed was immersed in methyl isobutyl ketone, methyl isobutyl ketone was poured thereto, so as to remove oil.

(Heating Treatment)

With respect to the sample 102 of containing a thermal polymerization initiator in a hard coat layer forming composition, after the step (4), a heating treatment was performed at 150° C. for five minutes, so as to cure the hard coat layer.

TABLE 1

| | | | Hard coat | | | | | | |
|---|---|---|---|---|---|---|---|---|---|
| | | | layer | Antireflection | | Lubricant a | | | Photopoly- |
| | Sample | | Coating | layer | Particle | | Acryl | Curable compound b | merization |
| | No. | Support | liquid | Coating liquid | dispersion | | equivalent | b-1/b-2/b-3 | initiator c |
| Example | 1 | TG60UL | Hard coat | Antireflection | Silica particle | Compound | 318 | SIRIUS-501/Compound | IRGACURE |
| | | | layer A | layer Aa1 | dispersion α | D | | B/KBM-4803 | 127 |
| Example | 2 | TG60UL | Hard coat | Antireflection | Silica particle | Compound | 368 | SIRIUS-501/Compound | IRGACURE |
| | | | layer A | layer Aa2 | dispersion α | E | | B/KBM-4803 | 127 |
| Example | 3 | TG60UL | Hard coat | Antireflection | Silica particle | P-10 | 225 | SIRIUS-501/Compound | IRGACURE |
| | | | layer A | layer Ab1 | dispersion α | | | B/KBM-4803 | 127 |
| Example | 4 | TG60UL | Hard coat | Antireflection | Silica particle | P-12 | 286 | SIRIUS-501/Compound | IRGACURE |
| | | | layer A | layer Ab2 | dispersion α | | | B/KBM-4803 | 127 |
| Example | 5 | TG60UL | Hard coat | Antireflection | Silica particle | P-13 | 344 | SIRIUS-501/Compound | IRGACURE |
| | | | layer A | layer Ab3 | dispersion α | | | B/KBM-4803 | 127 |
| Example | 6 | TG60UL | Hard coat | Antireflection | Silica particle | P-14 | 328 | SIRIUS-501/Compound | IRGACURE |
| | | | layer A | layer Ab4 | dispersion α | | | B/KBM-4803 | 127 |
| Example | 7 | TG60UL | Hard coat | Antireflection | Silica particle | 8SS-723 | 338 | SIRIUS-501/Compound | IRGACURE |
| | | | layer A | layer Ab5 | dispersion α | | | B/KBM-4803 | 127 |
| Example | 8 | TG60UL | Hard coat | Antireflection | Silica particle | 8SS-1024 | 263 | SIRIUS-501/Compound | IRGACURE |
| | | | layer A | layer Ab6 | dispersion α | | | B/KBM-4803 | 127 |
| Example | 9 | TG60UL | Hard coat | Antireflection | Silica particle | Compound | 262 | SIRIUS-501/Compound | IRGACURE |
| | | | layer A | layer Ac1 | dispersion α | S-1 | | B/KBM-4803 | 127 |
| Example | 10 | TG60UL | Hard coat | Antireflection | Silica particle | Compound | 417 | SIRIUS-501/Compound | IRGACURE |
| | | | layer A | layer Ac2 | dispersion α | S-2 | | B/KBM-4803 | 127 |
| Example | 11 | TG60UL | Hard coat | Antireflection | Silica particle | Compound | 372 | SIRIUS-501/Compound | IRGACURE |
| | | | layer A | layer Ac3 | dispersion α | S-3 | | B/KBM-4803 | 127 |
| Example | 12 | TG60UL | Hard coat | Antireflection | Silica particle | Compound | 172 | SIRIUS-501/Compound | IRGACURE |
| | | | layer A | layer Ac4 | dispersion α | S-4 | | B/KBM-4803 | 127 |
| Example | 13 | TG60UL | Hard coat | Antireflection | Silica particle | Compound | 254 | SIRIUS-501/Compound | IRGACURE |
| | | | layer A | layer Ac5 | dispersion α | S-5 | | B/KBM-4803 | 127 |
| Example | 14 | TG60UL | Hard coat | Antireflection | Silica particle | Compound | 254 | SIRIUS-501/Compound | IRGACURE |
| | | | layer A | layer Ac6 | dispersion β | S-5 | | B/KBM-4803 | 127 |
| Example | 15 | TG60UL | Hard coat | Antireflection | Silica particle | Compound | 254 | SIRIUS-501/Compound | IRGACURE |
| | | | layer A | layer Ac7 | dispersion γ | S-5 | | B/KBM-4803 | 127 |
| Example | 16 | TG60UL | Hard coat | Antireflection | Silica particle | Compound | 254 | SIRIUS-501/Compound | IRGACURE |
| | | | layer B | layer Ac5 | dispersion α | S-5 | | B/KBM-4803 | 127 |
| Example | 17 | TG60UL | Hard coat | Antireflection | Silica particle | Compound | 402 | SIRIUS-501/Compound | IRGACURE |
| | | | layer A | layer Ac8 | dispersion α | S-6 | | B/KBM-4803 | 127 |
| Example | 18 | TG60UL | Hard coat | Antireflection | Silica particle | Compound | 222 | SIRIUS-501/Compound | IRGACURE |
| | | | layer A | layer Ac9 | dispersion α | S-7 | | B/KBM-4803 | 127 |
| Example | 19 | TG60UL | Hard coat | Antireflection | Silica particle | Compound | 358 | SIRIUS-501/Compound | IRGACURE |
| | | | layer A | layer Ac10 | dispersion α | S-8 | | B/KBM-4803 | 127 |
| Example | 20 | TG60UL | Hard coal | Antireflection | Silica particle | Compound | 426 | SIRIUS-501/Compound | IRGACURE |
| | | | layer A | layer Ac11 | dispersion α | S-9 | | B/KBM-4803 | 127 |
| Example | 21 | TG60UL | Hard coal | Antireflection | Silica particle | Compound | 386 | SIRIUS-501/Compound | IRGACURE |
| | | | layer A | layer Ac12 | dispersion α | S-10 | | B/KBM-4803 | 127 |
| Example | 22 | TG60UL | Hard coat | Antireflection | Silica particle | Compound | 263 | SIRIUS-501/Compound | IRGACURE |
| | | | layer A | layer Ac13 | dispersion α | S-11 | | B/KBM-4803 | 127 |
| Example | 23 | TG60UL | Hard coat | Antireflection | Silica particle | Compound | 373 | SIRIUS-501/Compound | IRGACURE |
| | | | layer A | layer Ac14 | dispersion α | S-12 | | B/KBM-4803 | 127 |
| Comparative | 101 | TG60UL | Hard coat | Antireflection | Silica particle | Compound | — | U-15HA/X-12-1048 | IRGACURE |
| Example | | | layer A | layer Aa3 | dispersion α | C | | | 127 |
| Comparative | 102 | Substrate | Hard coat | Antireflection | Silica particle | Compound | — | SIRIUS-501/X-12-1048/ | IRGACURE |
| Example | | 1 | layer C | layer Aa4 | dispersion α | C | | KBM-4803 | 127 |
| Comparative | 103 | TG60UL | Hard coat | Antireflection | Silica particle | Compound | 3146 | SIRIUS-501/X-12-1048/ | IRGACURE |
| Example | | | layer A | layer Aa5 | dispersion α | F | | KBM-4803 | 127 |
| Comparative | 104 | TG60UL | Hard coat | Antireflection | Silica particle | UMS-182 | 545 | SIRIUS-501/X-12-1048/ | IRGACURE |
| Example | | | layer A | layer Ab7 | dispersion α | | | KBM-4803 | 127 |
| Comparative | 105 | TG60UL | Hard coat | Antireflection | Silica particle | P-11 | 669 | SIRIUS-501/X-12-1048/ | IRGACURE |
| Example | | | layer A | layer Ab8 | dispersion α | | | KBM-4803 | 127 |
| Comparative | 106 | TG60UL | Hard coat | Antireflection | Silica particle | X-22-164C | 2370 | SIRIUS-501/X-12-1048/ | IRGACURE |
| Example | | | layer A | layer Ac15 | dispersion α | | | KBM-4803 | 127 |
| Comparative | 107 | TG60UL | Hard coat | Antireflection | Silica particle | X-22-164 | 190 | SIRIUS-501/X-12-1048/ | IRGACURE |
| Example | | | layer A | layer Ac16 | dispersion α | | | KBM-4803 | 127 |
| Comparative | 108 | TG60UL | Hard coat | Antireflection | Silica particle | Compound | 166 | SIRIUS-501/X-12-1048/ | IRGACURE |
| Example | | | layer A | layer Ac17 | dispersion α | S-13 | | KBM-4803 | 127 |
| Comparative | 109 | TG60UL | Hard coat | Antireflection | Silica particle | Compound | 2482 | SIRIUS-501/X-12-1048/ | IRGACURE |
| Example | | | layer A | layer Ac18 | dispersion α | S-14 | | KBM-4803 | 127 |
| Comparative | 110 | TG60UL | Hard coat | Antireflection | Silica particle | Compound | 120 | SIRIUS-501/X-12-1048/ | IRGACURE |
| Example | | | layer A | layer Ac19 | dispersion α | S-15 | | KBM-4803 | 127 |
| Comparative | 111 | TG60UL | Hard coat | Antireflection | Silica particle | Compound | 862 | SIRIUS-501/X-12-1048/ | IRGACURE |
| Example | | | layer A | layer Ac20 | dispersion α | S-16 | | KBM-4803 | 127 |

[Steel Wool Resistance (Scratch Resistance Test)]

A rubbing test was performed on the antireflection layer surface of the antireflection film under the following conditions by using a rubbing tester so as to obtain an index of scratch resistance.

Evaluation environment condition: 25° C. and relative humidity of 60%

Rubbing material: Steel wool (manufactured by Nippon Steel Wool Co., Ltd., Grade No. 0000)

A band was wrapped around a rubbing tip portion (1 cm×1 cm) of the tester in contact with the sample and was fixed

Travel distance (one way): 13 cm,

Rubbing speed: 13 cm/sec,

Load: 200 g/cm²,

Tip portion contact area: 1 cm×1 cm,

Number of rubbing: 10 round trips

Oily black ink (Teranishi Chemical Industry Co., Ltd., magic black ink for filling) was applied to the back side of the rubbed sample and visually observed with reflected light, so as to evaluate scratches on the rubbed portion.

A+: The number of scratches was 0

A: The number of scratches was 1 or more and within 2

B: The number of scratches was 3 or more and within 5

C: The number of scratches was 6 or more

[Specular Reflectance]

The back surface (substrate side) of the antireflection film was roughened with a sand paper and then treated with oily black ink so as to prepare a film sample from which back surface reflection is removed.

(Specular Reflectance)

The unit ARM-500v is mounted to a spectrophotometer V-550 (manufactured by JASCO Corporation), the reflectance is measured in the wavelength range of 450 to 650 nm at an incidence angle of 5°, and the average reflectance is taken as a specular reflectance.

(Difference Between Specular Reflectances Before and after Steel Wool Scratch Resistance Test)

In a case where a specular reflectance after a steel wool scratch resistance test was R_{A} and a specular reflectance before rubbing with steel wool was R₀, a reflectance change represented by (R_{A}-R₀) was calculated.

[Content of Low Friction Moiety of Lubricant (a)]

The film was cut with a microtome, and the cross section was analyzed with a time-of-flight secondary ion mass spectrometer (TOF-SIMS), and a state of an area (near the surface) from the outermost surface to the depth of 20 nm was observed. 100*(X/Y) in a case where X is a fluorine amount and a silicone (siloxane bond) amount near the surface of the antireflection layer, Y is a fluorine amount in a single film of the lubricant (a) or a silicone (siloxane bond) amount was calculated. A F⁻ fragment or a Si₂C₅H₁₅O⁺ fragment was detected as a secondary ion representing a low friction moiety of the lubricant (a).

TABLE 2

| | | | | Difference | Content |
|---|---|---|---|---|---|
| | | | Specular | between | of |
| | | Steel wool | reflectance | reflectances | lubricant |
| | Sample | resistance | % | % | % |
| Example | 1 | A | 0.4 | 0.06 | 80 |
| Example | 2 | A | 0.4 | 0.15 | 90 |
| Example | 3 | A+ | 0.5 | 0.03 | 75 |
| Example | 4 | A+ | 0.5 | 0.03 | 75 |
| Example | 5 | A+ | 0.5 | 0.05 | 75 |
| Example | 6 | A+ | 0.5 | 0.05 | 75 |
| Example | 7 | A+ | 0.5 | 0.06 | 70 |
| Example | 8 | A+ | 0.5 | 0.03 | 70 |
| Example | 9 | A | 0.4 | 0.06 | 55 |
| Example | 10 | A+ | 0.4 | 0.25 | 60 |
| Example | 11 | A | 0.4 | 0.20 | 55 |
| Example | 12 | A+ | 0.5 | 0.01 | 60 |
| Example | 13 | A+ | 0.3 | 0.00 | 60 |
| Example | 14 | A+ | 0.5 | 0.04 | 60 |
| Example | 15 | A+ | 0.7 | 0.02 | 60 |
| Example | 16 | A+ | 0.3 | 0.00 | 60 |
| Example | 17 | A | 0.4 | 0.25 | 60 |
| Example | 18 | A | 0.4 | 0.20 | 55 |
| Example | 19 | A | 0.4 | 0.06 | 60 |
| Example | 20 | A | 0.4 | 0.25 | 60 |
| Example | 21 | A | 0.4 | 0.20 | 55 |
| Example | 22 | A+ | 0.3 | 0.00 | 60 |
| Example | 23 | A | 0.4 | 0.06 | 60 |
| Comparative | 101 | C | 0.7 | 0.35 | 80 |
| Example | | | | | |
| Comparative | 102 | C | 0.4 | 0.35 | 80 |
| Example | | | | | |
| Comparative | 103 | C | 0.6 | 0.30 | 85 |
| Example | | | | | |
| Comparative | 104 | B | 0.7 | 0.30 | 75 |
| Example | | | | | |
| Comparative | 105 | B | 0.6 | 0.33 | 75 |
| Example | | | | | |
| Comparative | 106 | C | 0.5 | 0.30 | 60 |
| Example | | | | | |
| Comparative | 107 | C | 0.6 | 0.40 | 20 |
| Example | | | | | |
| Comparative | 108 | B | 0.7 | 0.30 | 45 |
| Example | | | | | |
| Comparative | 109 | C | 0.6 | 0.34 | 60 |
| Example | | | | | |
| Comparative | 110 | B | 0.7 | 0.27 | 50 |
| Example | | | | | |
| Comparative | 111 | B | 0.6 | 0.32 | 55 |
| Example | | | | | |

From the results in able 2, it as checked that the sample containing the lubricant (a) having a small acryl equivalent of the present invention and a high crosslinking density in the vicinity of the surface opposite to the substrate in the antireflection layer has low reflectance and satisfactory steel wool rubbing resistance, low reflectance increase after steel wool rubbing, and excellent scratch resistance in practice.

The following saponification treatment was performed on Sample Nos. 13 and 22. A 1.5 mol/l sodium hydroxide aqueous solution was prepared and maintained at 55° C. A 0.01 mol/l diluted sulfuric acid aqueous solution was prepared and maintained at 35° C. The prepared optical film was immersed in the above sodium hydroxide aqueous solution for two minutes and then immersed in water so as to sufficiently rinse out the sodium hydroxide aqueous solution. The film was immersed in the above diluted sulfuric acid aqueous solution for one minute and then immersed in water, to sufficiently rinse out the diluted sulfuric acid aqueous solution. The sample was sufficiently dried at 120° C.

While Sample No. 13 maintained steel wool resistance A+ even after the saponification treatment and was satisfactory, it was checked that the steel wool resistance of Sample No. 22 was deteriorated to A.

According to the present invention, it is possible to provide an antireflection film having satisfactory antireflection performance, a small reflectance change before and after a scratch resistance test, and excellent practical scratch resistance, and it is possible to suggest a method of easily manufacturing the antireflection film.

The present invention has been described in detail and with reference to specific embodiments, but it is obvious to those skilled in the art that various changes and modifications can be made without departing from the spirit and scope of the present invention.

This application is based on Japanese patent application (JP2016-033786) filed on Feb. 25, 2016, and the contents thereof are incorporated herein by reference.

### EXPLANATION OF REFERENCES

1 substrate
2 antireflection layer
3 particle
4 layer (A), resin
10 antireflection film
A distance between peaks of adjacent protrusions
B distance between the center of peaks of adjacent protrusions and recessed part
S area (S)
t film thickness of area (S)

What is claimed is:

1. An antireflection film comprising:
at least one antireflection layer on a substrate,
wherein the antireflection layer comprises a cured product of a curable composition comprising
a lubricant (a) having three or more crosslinking groups in one molecule, having a crosslinking group equivalent of 450 or less, and having a moiety including at least one of a fluorine atom or a siloxane bond,
a curable compound (b) having three or more crosslinking groups in at least one molecule, having a crosslinking group equivalent of 450 or less, and not having both of a fluorine atom and a siloxane bond, and
a photopolymerization initiator (c),
in an area (S) having a thickness of 20 nm or less in a direction from an outermost surface of the antireflection layer, opposite to a surface of the antireflection layer at a side of the substrate, toward the substrate, and
has an area having a content of the lubricant (a) of 51% or more in a material distribution in a cross section direction of the area (S).

2. The antireflection film according to claim 1,
wherein, in a case where a reflectance of the antireflection film after the outermost surface of the antireflection layer, opposite to the surface of the antireflection layer at a side of the substrate, is rubbed by 10 round trips with steel wool in a condition of a load of 200 g is set as R_{A}, and a reflectance of the antireflection film before being rubbed with steel wool is set as R₀, a reflectance change represented by R_{A}-R₀ is 0.25% or less.

3. The antireflection film according to claim 1,
wherein the crosslinking group of the lubricant (a) is a (meth)acryloyl group.

4. The antireflection film according to claim 1,
wherein the moiety including at least one of a fluorine atom or a siloxane bond of the lubricant (a) is a fluoroalkyl group.

5. The antireflection film according to claim 1,
wherein the moiety including at least one of a fluorine atom or a siloxane bond of the lubricant (a) is a polydimethylsiloxane group or a polyether-modified dimethylsiloxane group.

6. The antireflection film according to claim 4,
wherein the lubricant (a) is a compound (a1) having the moiety including at least one of a fluorine atom or a siloxane bond and the crosslinking group in a side chain of the compound (a1) and having a weight-average molecular weight of 6,000 or more.

7. The antireflection film according to claim 6,
wherein, in the compound (a1), the crosslinking group is linked to a main chain of the compound (a1) via a C—C bond or a C—O bond.

8. The antireflection film according to claim 4,
wherein the lubricant (a) is a compound (a2) in which the crosslinking group is bonded to the moiety including at least one of a fluorine atom or a siloxane bond directly or via a linking group and which has a weight-average molecular weight of less than 6,000.

9. The antireflection film according to claim 8,
wherein the compound (a2) is
a compound having one group represented by the following Formula (M-2),
a compound having one group represented by the following Formula (M-3),
a compound having two groups represented by the following Formula (M-1),
a compound having two groups represented by the following Formula (M-2), or
a compound having two groups represented by the following Formula (M-3), 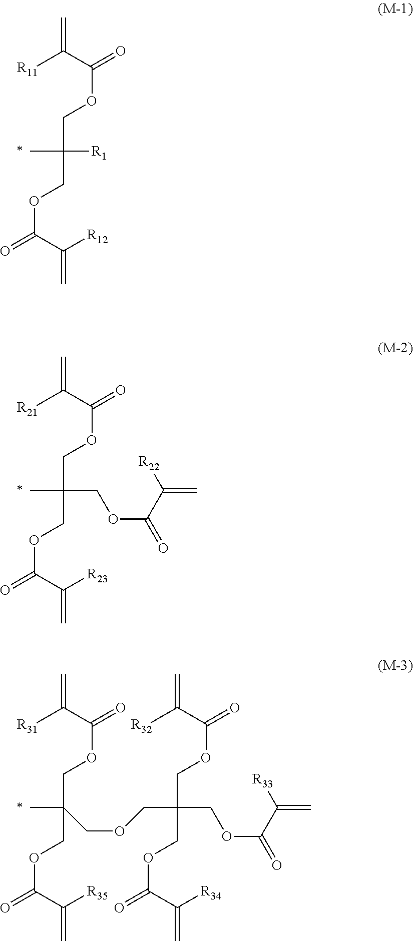
in the Formula (M-1), R₁ represents a hydrogen atom, an alkyl group, an alkenyl group, an alkyloxy group, an alkenyloxy group, an alkyloxyalkyl group, or an alkenyloxyalkyl group, R₁₁ and R₁₂ each independently represent a hydrogen atom or a methyl group, and * represents a bonding position,
in the Formula (M-2), R₂₁ to R₂₃ each independently represent a hydrogen atom or a methyl group, and * represents a bonding position, and
in the Formula (M-3), R₃₁ to R₃₅ each independently represent a hydrogen atom or a methyl group, and * represents a bonding position.

10. The antireflection film according to claim 8,
wherein, in the compound (a2), the moiety including at least one of a fluorine atom or a siloxane bond and the crosslinking group are bonded to each other via a C—C bond or a C—O bond.

11. The antireflection film according to claim 1,
wherein the antireflection layer has a particle (d) having an average primary particle diameter of 250 nm or less.

12. The antireflection film according to claim 11, having an uneven shape formed by the particle (d) on the surface of the antireflection layer opposite to the surface of the antireflection layer at a side of the substrate.

13. The antireflection film according to claim 1,
wherein a transmittance of visible light with respect to the substrate is 80% or more.

14. The antireflection film according to claim 12,
wherein a plurality of the particles (d) are not present in a direction orthogonal to a surface of the substrate in the antireflection layer.

15. A method of manufacturing the antireflection film according to claim 12, comprising, in order:
a step (1) of coating the substrate with a composition comprising the lubricant (a), the curable compound (b), the photopolymerization initiator (c), the particle (d), and a solvent, and volatilizing the solvent, to provide a layer (A) in which a thickness of a portion in which the particle (d) is not present has a thickness of 0.8 times or more of the average primary particle diameter of the particle (d);
a step (2) of curing a portion of the curable compound (b) in the layer (A) so as to obtain a cured compound (bc);
a step (3) of permeating a portion of a compound selected from the group consisting of the curable compound (b) and the compound (bc) in the layer (A) to the substrate by heating or volatilizing the portion so as to form an uneven shape formed by the particle (d) on an outermost surface of the layer (A) opposite to a surface of the layer (A) at a side of the substrate; and
a step (4) of curing a compound selected from the group consisting of the lubricant (a), the curable compound (b), and the compound (bc) remaining in the layer (A) so as to form the antireflection layer.

16. The method of manufacturing an antireflection film according to claim 15, further comprising:
a step (E1) of providing a layer (E) comprising a compound (e) incompatible with the curable compound (b) on the surface of the layer (A) opposite to the surface of the layer (A) at a side of the substrate, between the step (1) and the step (2), between the step (2) and the step (3), or between the step (3) and the step (4); and
a step (E2) of removing the layer (E) after the step (2), the step (3), or the step (4) subsequent to the step (E1).
